(19) United States
(12) Patent Application Publication
(10) Pub. No.: US 2014/0129607 A1
(43) Pub. Date: May 8, 2014

(54) INFORMATION PROCESSING APPARATUS, INFORMATION PROCESSING SYSTEM, AND INFORMATION PROCESSING METHOD

(71) Applicant: Taku NAGUMO, Kanagawa (JP)

(72) Inventor: Taku NAGUMO, Kanagawa (JP)

(73) Assignee: RICOH COMPANY, LTD., Tokyo (JP)

(21) Appl. No.: 14/068,094

(22) Filed: Oct. 31, 2013

(30) Foreign Application Priority Data
Nov. 8, 2012 (JP) 2012-246250

(51) Int. Cl. H04L 29/08

(52) U.S. Cl. CPC H04L 67/02
USPC 709/201

(57) ABSTRACT

An information processing apparatus includes an order information storage part that stores order information defining an order in which a plurality of processes are to be executed with respect to data; a setting part that prompts selection of a processing apparatus that is to execute a process of the plurality of processes from one or more processing apparatuses, and stores association information indicating an association between the process and the selected processing apparatus in an association storage part; and an order control part that prompts the one or more processing apparatuses that are associated with the plurality of processes to execute the plurality of processes in the order defined by the order information.

### BACKGROUND OF THE INVENTION

1. Field of the Invention

The disclosures herein relate to an information processing apparatus, an information processing system, and an information processing method.

2. Description of the Related Art

Service providing architectures that use software provided over a network such as the Internet rather than running an application program at an information processing apparatus directly operated by a user are becoming widespread. A cloud service is one known example of such service providing architecture (See e.g., Japanese Laid-Open Patent Publication No. 2011-192250).

Conventionally, processes of services provided over a network are relatively fixed. Thus, program code changes and other burdensome operations may be required each time processes are to be configured for a given user activity, for example.

Such a problem is not limited to cloud services but applies universally to any type of service provided via a network including a service provided by an ASP (Application Service Provider) or a web service, for example.

### SUMMARY OF THE INVENTION

It is an object of at least one embodiment of the present invention to provide a technique for enhancing flexibility of a service provided over a network.

According to one embodiment of the present invention, an information processing apparatus includes an order information storage part that stores order information defining an order in which a plurality of processes are to be executed with respect to data; a setting part that prompts selection of a processing apparatus that is to execute a process of the plurality of processes from one or more processing apparatuses, and stores association information indicating an association between the process and the selected processing apparatus in an association storage part; and an order control part that prompts the one or more processing apparatuses that are associated with the plurality of processes to execute the plurality of processes in the order defined by the order information.

According to an aspect of the present invention, a service provided over a network may be flexibly configured.

### BRIEF DESCRIPTION OF THE DRAWINGS

FIG. 1 illustrates an exemplary configuration of an information processing system according to an embodiment of the present invention;

FIG. 2 illustrates an exemplary hardware configuration of a service providing apparatus according an embodiment of the present invention;

FIG. 3 illustrates an exemplary hardware configuration of an image forming apparatus according an embodiment of the present invention;

FIG. 4 illustrates an exemplary conceptual model of a workflow according to an embodiment of the present invention;

FIG. 5 illustrates an exemplary functional configuration of the service providing apparatus;

FIG. 6 illustrates an exemplary functional configuration of a device according to an embodiment of the present invention;

FIG. 7 illustrates exemplary process steps of preparatory operations performed by an administrator to enable use of a service;

FIG. 8 illustrates exemplary screens that are displayed at an administrator terminal during the preparatory operations;

FIG. 9 illustrates an exemplary configuration of a user information storage part;

FIG. 10 illustrates an exemplary manner of describing device information in a device information file;

FIG. 11 illustrates an exemplary configuration of a device information storage part;

FIG. 12 illustrates an exemplary set of screens for registering account information of a cooperation target storage;

FIG. 13 illustrates another set of exemplary screens for registering account information of a cooperation target storage;

FIG. 14 illustrates an example where additional storage account information is added to the user information storage part;

FIG. 15 illustrates an exemplary manner in which user information is described in a user information file;

FIG. 16 illustrates an exemplary workflow generation screen;

FIG. 17 illustrates an exemplary configuration of a workflow definition storage part;

FIG. 18 illustrates an exemplary configuration of workflow information;

FIG. 19 illustrates an exemplary conceptual model of a profile;

FIG. 20 illustrates an exemplary display of a profile edit screen;

FIG. 21 illustrates an exemplary input task setting screen;

FIG. 22 illustrates an exemplary process task setting screen;

FIG. 23 illustrates an exemplary output task setting screen;

FIG. 24 illustrates an exemplary configuration of a profile storage part;

FIG. 25 illustrates an exemplary display of a profile-device setting screen;

FIG. 26 illustrates an exemplary configuration of a profile-device correspondence storage part;

FIG. 27 is a sequence chart illustrating exemplary process steps that are executed upon using a workflow service according an embodiment of the present invention;

FIG. 28 illustrates an exemplary display of an operation screen of a workflow device application;

FIG. 29 illustrates an exemplary workflow for a first use case;

FIG. 30 illustrates an exemplary workflow for a second use case;

FIG. 31 illustrates an exemplary workflow for a third use case; and

FIG. 32 illustrates an exemplary workflow for a fourth use case.

### DESCRIPTION OF THE PREFERRED EMBODIMENTS

In the following, embodiments of the present invention are described with reference to the accompanying drawings.

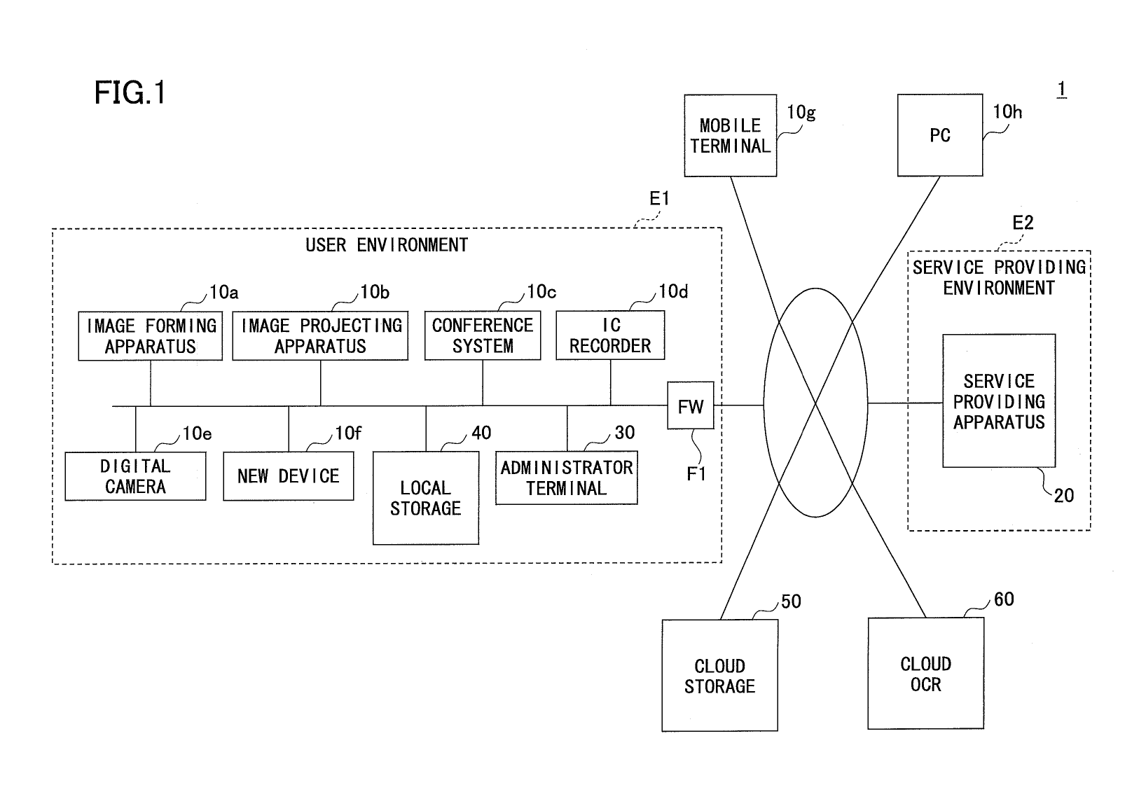

FIG. 1 illustrates an exemplary configuration of an information processing system 1 according to an embodiment of the present invention. In the example illustrated in FIG. 1, the information processing system 1 includes a service providing environment E2, a user environment E1, a cloud storage 50, and a cloud OCR (Optical Character Recognition) 60 that are connected via a wide area network such as the Internet so that they may establish communication with each other.

The service providing environment E2 is a system environment of an organization that provides a cloud service via a network. Note that although a cloud service is illustrated as an exemplary service provided via a network in the descriptions below, embodiments of the present invention may also be implemented in systems that provide some other type of service via a network such as a service provided by an ASP or a web service.

The service providing environment E2 includes a service providing apparatus 20. The service providing apparatus 20 is configured to provide a predetermined service via a network. For example, the service providing apparatus 20 may be configured to provide a workflow service, which is described in detail below. “Workflow service” refers to a service that executes processes according to a workflow, which is defined by a user within the user environment E1. “Workflow,” which is described in detail below, refers to a definition of an order in which a number of processes are to be executed with respect to data. Note that in certain embodiments, the service providing apparatus 20 may be arranged within the user environment E1. That is, the service providing environment E2 may be included within the user environment E1.

The user environment E1 is a system environment of an organization such as a company corresponding to an exemplary user of the workflow service. The user environment E1 illustrated in FIG. 1 includes a number of devices including an image forming apparatus 10a, an image projecting apparatus 10b, a conference system 10c, an IC recorder 10d, a digital camera 10e, and some other new device 10f ; an administrator terminal 30; and a local storage 40. The above devices and other components are connected via a network such as a LAN (local area network).

The image forming apparatus 10a is a device having a scanning function and/or a printing function, for example. The image forming apparatus 10a may also have other functions such as a copying function, and a facsimile communication function.

The image projecting apparatus 10b is a device such as a projector that projects image data. The conference system 10c may be a teleconference system that displays video images, for example. The IC recorder 10d is a device that records audio data. The digital camera 10e is a device that captures image data.

The administrator terminal 30 is a terminal used by an administrator of the image forming apparatus 10a within the user environment E1. For example, the administrator terminal 30 may be a PC (personal computer), a PDA (personal digital assistant), a tablet terminal, a smart phone, or a cell phone.

The local storage 40 is a data storage device that may be a candidate for an input source of data subject to a workflow or an output destination for data output from a workflow.

The user environment E1 further includes a firewall F1. The firewall F1 may be any type of firewall that is commonly used, for example. The firewall F1 may block a request that is transmitted from the exterior to the user environment E1, for example. Thus, the firewall F1 may prevent an active request from being transmitted from the service providing apparatus 20 to the image forming apparatus 10a within the user environment E1, for example.

The cloud storage 50 is a computer system that provides a cloud service called “online storage” via a network. “Online storage” refers to a service that rents out a storage area for storing data. In the present example, the storage area rented out by the online storage may be a candidate for an input source of data subject to a workflow or an output destination for data output from a workflow.

Note that in the following descriptions, the cloud storage 50 and the local storage 40 may simply be referred to as “storage” when the distinction between the two is irrelevant.

The cloud OCR 60 is a computer system that provides a cloud service relating to an OCR (Optical

Character Recognition) process for image data via a network. Note that the information processing system 1 may also include other computer systems that provide other cloud services relating to data processes such as a translation process for text data, a summarization process for text data, or a conversion process for converting a data format, for example.

The service providing environment E2 may be accessible from environments other than the user environment E1. For example, a mobile terminal 10g or a PC 10h may access the service providing apparatus 20 via the Internet. The mobile terminal 10g and the PC 10h may be used within the user environment E1 or outside the user environment E1. The mobile terminal 10g may be a mobile phone, a smart phone, or a tablet terminal, for example.

Note that the image forming apparatus 10a, the image projecting apparatus 10b, the conference system 10c, the IC recorder 10d, the digital camera 10e, the new device 10f, the mobile terminal 10g, and the PC 10h may simply be referred to as “device 10” when the distinctions between the above devices are irrelevant. The device 10 may be a candidate for an input source of data such as image data subject to a workflow, an output destination for data resulting from executing a workflow, an executing center or an executing location of a data process for electronic data, for example. In one specific example, the mobile terminal 10g such as a smart phone may be an input source that inputs image data by installing and running an application that implements a function similar to that of a scanner, for example.

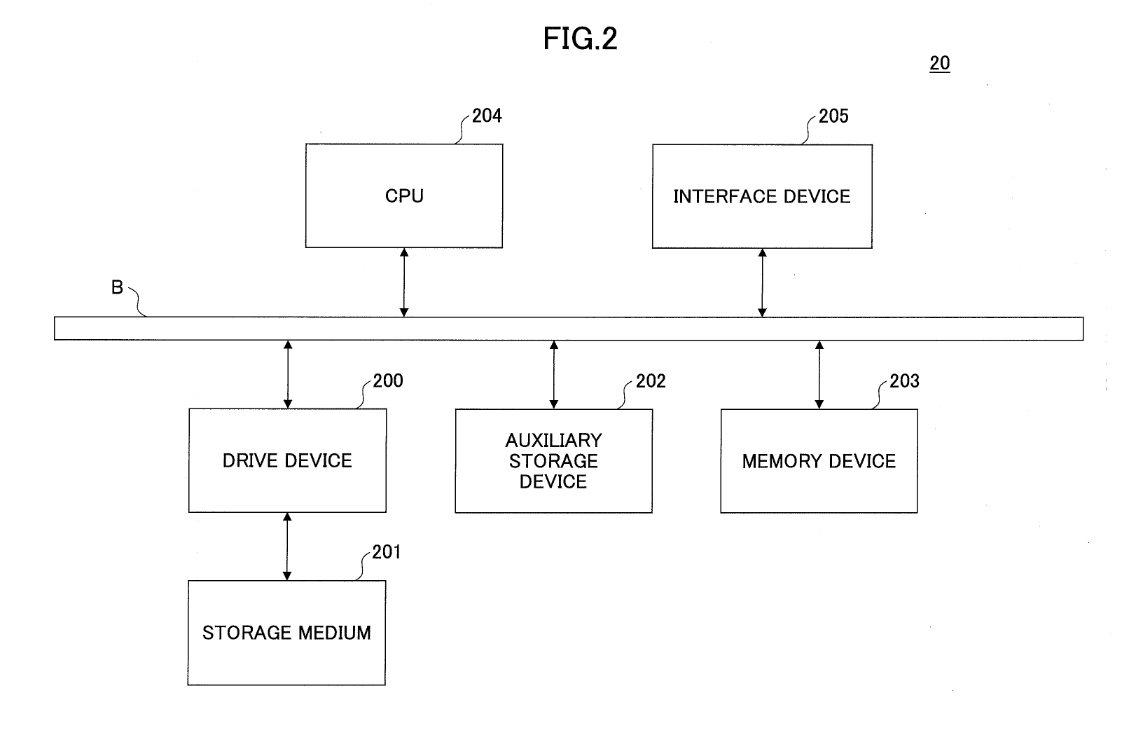

FIG. 2 illustrates an exemplary hardware configuration of the service providing apparatus 20 according to an embodiment of the present invention. In FIG. 2, the service providing apparatus 20 includes a drive device 200, an auxiliary storage device 202, a memory device 203, a CPU (central processing unit) 204, and an interface device 205.

A program for executing a process of the service providing apparatus 20 may be stored in a storage medium 201, which may be a CD-ROM (compact disc read-only memory), for example. When the storage medium 201 storing the program is loaded into the drive device 200, the program may be installed in the auxiliary storage device 202 from the storage medium 201 via the drive device 200. Note however, that the program does not necessarily have to be installed via the storage medium 201, but may alternatively be downloaded from another computer via a network, for example. The auxiliary storage device 202 is configured to store the installed program as well as other necessary files and data.

The memory device 203 reads the program from the auxiliary storage device 202 and stores the read program in response to the issuance of a program activation command. The CPU 204 executes various functions of the service providing apparatus 20 according to the program stored in the memory device 203. The interface device 205 is used as an interface for establishing connection with a network.

In certain embodiments, the service providing apparatus 20 may include a plurality of computers having the hardware configuration as illustrated in FIG. 2. That is, in certain embodiments, a plurality of computers may be configured to execute one or more processes of the service providing apparatus 20 that are described in detail below.

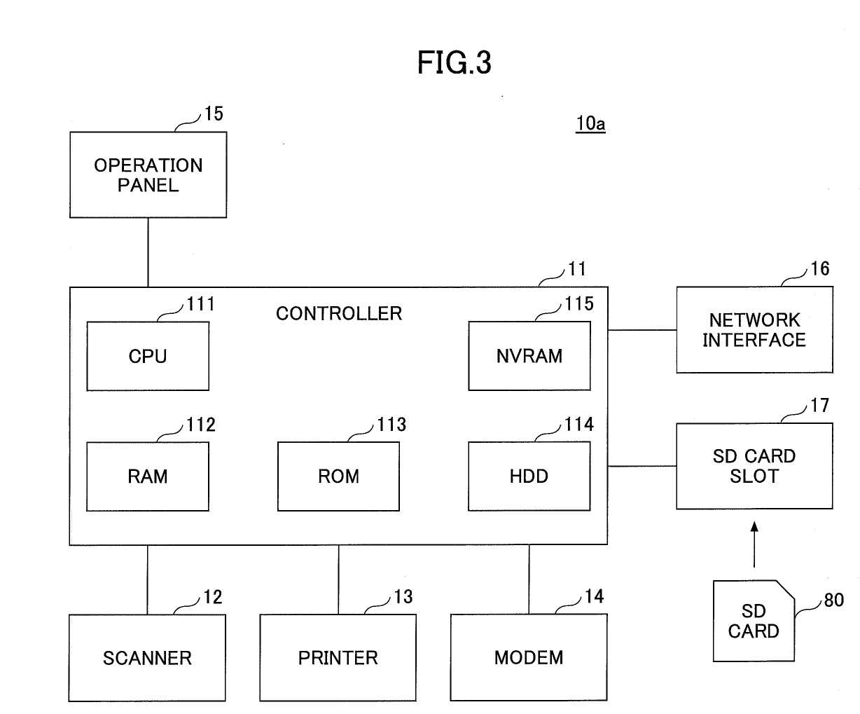

FIG. 3 illustrates an exemplary hardware configuration of the image forming apparatus 10a according to an embodiment of the present invention. In FIG. 3, the image forming apparatus 10a includes hardware components such as a controller 11, a scanner 12, a printer 13, a modem 14, an operation panel 15, a network interface 16, and a SD card slot 17.

The controller 11 includes a CPU 111, a RAM (random access memory) 112, a ROM (read-only memory) 113, a HDD (hard disk drive) 114, and a NVRAM (non-volatile random access memory) 115. The ROM 113 stores various programs and data that are used by the programs. The RAM 112 is used as a storage area for loading a program and a working area for the loaded program. The CPU 111 implements one or more functions of the image forming apparatus 10a by executing the program loaded in the RAM 112. The HDD 114 stores various programs and data that are used by the programs. The NVRAM 115 stores various items of information such as setting information.

The scanner 12 is hardware for scanning (inputting) image data of a document. The printer 13 is hardware for printing print data on a printing sheet. The modem 14 is hardware for establishing connection with a telephone line and is used to transmit and receive image data through facsimile communication. The operation panel 15 is hardware including an input unit such as a button for accepting an input from a user and a display unit such as a liquid crystal display panel. The network interface 16 is hardware for establishing connection with a wireless or wired network such as a LAN. The SD card slot 17 is used to read programs stored in an SD card 80. In the image forming apparatus 10a of present embodiment, the programs stored in the SD card 80 as well as the programs stored in the ROM 113 may be loaded on the RAM 112 and executed. In other embodiments, some other type of storage medium such as a CD-ROM or a USB (universal serial bus) may be used instead of the SD card 80. That is, the type of the storage medium storing the programs to be read and loaded on the RAM 112 of the image forming apparatus 10a is not limited to a particular type of storage medium. Also, the SD card slot 17 may be replaced by suitable hardware for reading the programs according to the type of storage medium used.

Note that descriptions of the hardware configurations of the other devices 10 are omitted for the sake of convenience.

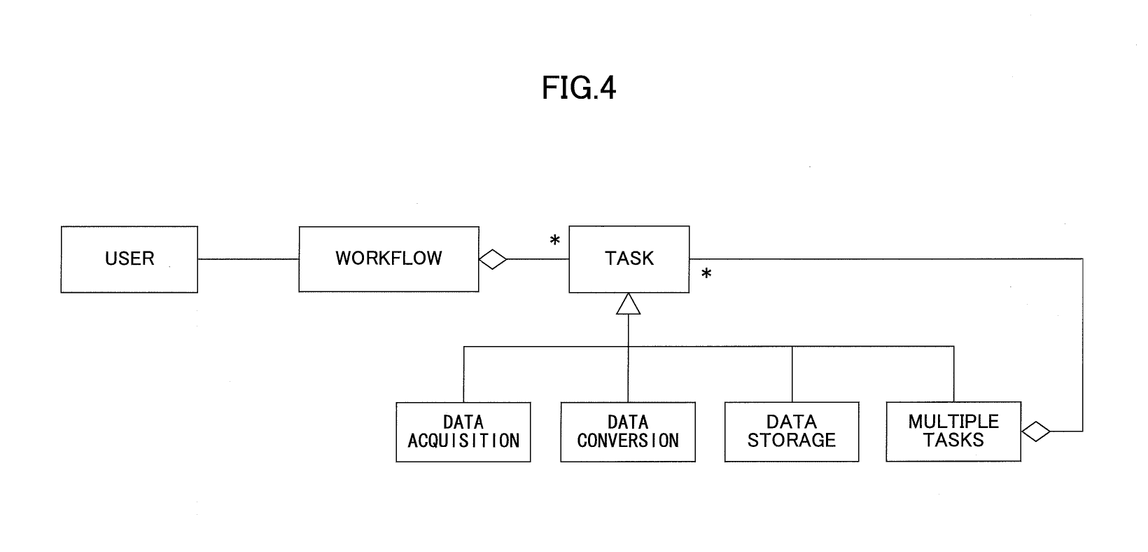

In the following, basic concepts of a workflow are described. FIG. 4 illustrates an exemplary conceptual model of a workflow according to an embodiment of the present invention.

A workflow may be regarded as a flow of a series of processes that provide value to a user. One workflow includes multiple tasks that are to be executed in a specific order. A task is a process unit of a workflow. A combination and order of processes of a workflow are defined in task units. Examples of tasks include data acquisition, data conversion, data storage, notification by mail, and log storage. Also, a composite task made up of multiple tasks may be defined.

A task may be categorized as an I/O (input/output) task or a process task according to its corresponding process operation. An I/O task refers to a task for executing a data input operation or a data output operation. More specifically, a task for executing a data input operation is referred to as input task, and a task for executing a data output operation is referred to as an output task.

A process task refers to a task for executing a data processing operation or some other operation on data input by an input task or data output by some other process task.

One workflow may start with an input task, include one or more process tasks as is necessary, and end with an output task, for example. Note, however, that a workflow does not necessarily have to end with an output task and may alternatively end with a process task. In other examples, a workflow may not include any process tasks.

Examples of an input task include the image forming apparatus 10a scanning image data from a paper medium, and the digital camera 10e capturing image data of an object.

Examples of an output task include spooling a PDF (Portable Document Format) document or PDL (Page Description Language) data in the image forming apparatus 10a, and storing data in the local storage 40 or the cloud storage 50.

Examples of a process task include an OCR (Optical Character Recognition) process for image data, a translation process for text data, a data format conversion process, a summarization process for text data, a reporting process for reporting the execution of some type of process, and a data delivery process.

Note that the above tasks may be implemented by programs. Accordingly, a workflow may be regarded as a definition of an execution order of programs corresponding to certain tasks.

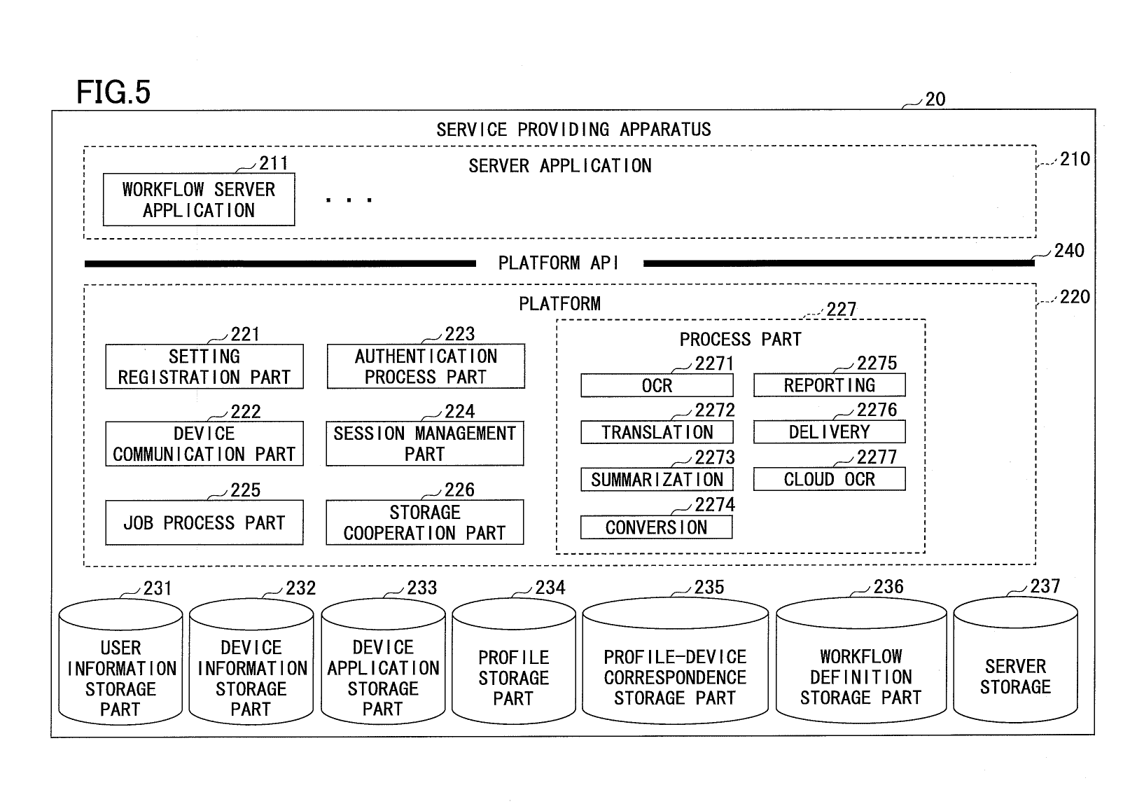

FIG. 5 illustrates an exemplary functional configuration of the service providing apparatus 20 according to an embodiment of the present invention. In FIG. 5, the service providing apparatus 20 includes software components such as a server application 210 and a platform 220. These software components are implemented by one or more programs that are installed in the service providing apparatus 20 and executed by the CPU 204.

The service providing apparatus 20 also includes a user information storage part 231, a device information storage part 232, a device application storage part 233, a profile storage part 234, a profile-device correspondence storage part 235, a workflow definition storage part 236, and a server storage 237. These storage parts may be implemented by the auxiliary storage device 202 or some other storage device that is connected to the service providing apparatus 20 via a network, for example.

The server application 210 is an application program for implementing a service provided by the service providing apparatus 20. Note that the term “server application” is used to refer to an application program at the service providing apparatus 20 side as distinguished from an application program at the device 10 side (e.g., workflow device application 125, which is described below).

In FIG. 5, a workflow server application 211 is illustrated as an example of the server application 210. The workflow server application 211 is an application program for executing processes of a workflow service.

The platform 220 may include a common function of a plurality of the server applications 210 or a basic function used by the plurality of the server applications 210. In FIG. 5, the platform 220 includes a setting registration part 221, a device communication part 222, an authentication process part 223, a session management part 224, a job process part 225, a storage cooperation part 226, and a process part 227. The functions enabled by these functional parts are notified to the server application 210 via a platform API 240. That is, the server application 210 is able to use the functions of the platform 220 to the extent they are published by the platform API 240.

The setting registration part 221 executes a setting registration process that needs to be performed before starting use of a service provided by the service providing apparatus 20. The setting registration part 221 may be used to register information in the user information storage part 231, the device information storage part 232, the profile storage part 234, the profile-device correspondence storage part 235, and the workflow definition storage part 226, for example.

The user information storage part 231 stores information relating to a user of a service provided by the service providing apparatus 20. The device information storage part 232 stores information relating to the devices 10 that are to cooperate with the service provided by the service providing apparatus 20 within the system environment of the user (i.e., user environment E1). That is, a service provided by the service providing apparatus 20 such as a workflow service is implemented through cooperation of the server application 210 with one or more devices 10 within the user environment E1.

The device application storage part 233 stores an application program that needs to be installed in the device 10 for enabling cooperation between the server application 210 and the device 10 (referred to as “device application” hereinafter). The profile storage part 234 stores one or more profiles. A profile may include configuration information of an operation screen of a device application and information on a process to be executed in response to an operation of the operation screen, for example. The profile-device correspondence storage part 235 stores information relating to the correspondence between a profile and a device 10. That is, in the present embodiment, a corresponding profile for an operation screen for a device application may be assigned to each of the devices 10 within the user environment E1. The workflow definition storage part 236 stores definition information of a workflow (e.g., information indicating the execution order of tasks).

The device communication part 222 controls communication between the service providing apparatus 20 and the device 10. The authentication process part 223 authenticates the user of the administrator terminal 30 or the user of the device 10. Also, the authentication process part 223 may act as a proxy for executing a login process for gaining login access to the cloud storage 50 during execution of a workflow service, for example. The session management part 224 manages a session between the service providing apparatus 20 and the device 10 during their cooperation.

The job process part 225 controls execution of a job in response to a job execution request from the server application 210. The storage cooperation part 226 enables cooperation between the service providing apparatus 20 and the cloud storage 50.

The process part 227 corresponds to a collection of program modules that execute process tasks of a workflow (referred to as “process modules” hereinafter). In FIG. 5, an OCR module 2271, a translation module 2272, a summarization module 2273, a conversion module 2274, a reporting module 2275, a delivery module 2276, and a cloud OCR module 2277 are illustrated as exemplary process modules.

The OCR module 2271 prompts the service providing apparatus 20 to execute an OCR process on image data. The translation module 2272 prompts the service providing apparatus 20 to execute a translation process on text data. The summarization module 2273 prompts the service providing apparatus 20 to execute a summarization process on the information content of text data. The conversion module 2274 prompts the service providing apparatus 20 to execute a data format conversion process. The reporting module 2275 prompts the service providing apparatus 20 to execute a reporting process for reporting the completion of a predetermined process, for example. The delivery module 2276 prompts the service providing apparatus 20 to execute a data delivery process for delivering data to a designated delivery destination. The cloud OCR module 2277 is a process module that wraps the interface of the cloud OCR 60 so that the cloud OCR 60 may be used just like the other process modules. For example, the cloud OCR 2277 may have the same interface as the OCR module 2271. In the case of cooperating with a computer system outside the service providing apparatus 20 and having such computer system execute a process task, a program module that wraps the interface of the computer system and provides a common interface as a process module may be installed in the service providing system 20, for example.

Like the local storage 40 and the cloud storage 50, the server storage 237 is a data storage device that may be a candidate for an input source of data subject to a workflow or an output destination of data output from a workflow, for example.

Note that the manner in which software components and storage parts of the service providing apparatus 20 are arranged in FIG. 5 is merely one illustrative example. That is, the software components and storage parts of the service providing apparatus 20 do not necessarily have to be arranged into a layer configuration as illustrated in FIG. 5. Rather, the software components and storage parts of the service providing apparatus 20 may be arranged in any suitable configuration so long as cooperation between the server application 210 and the device 10 is enabled.

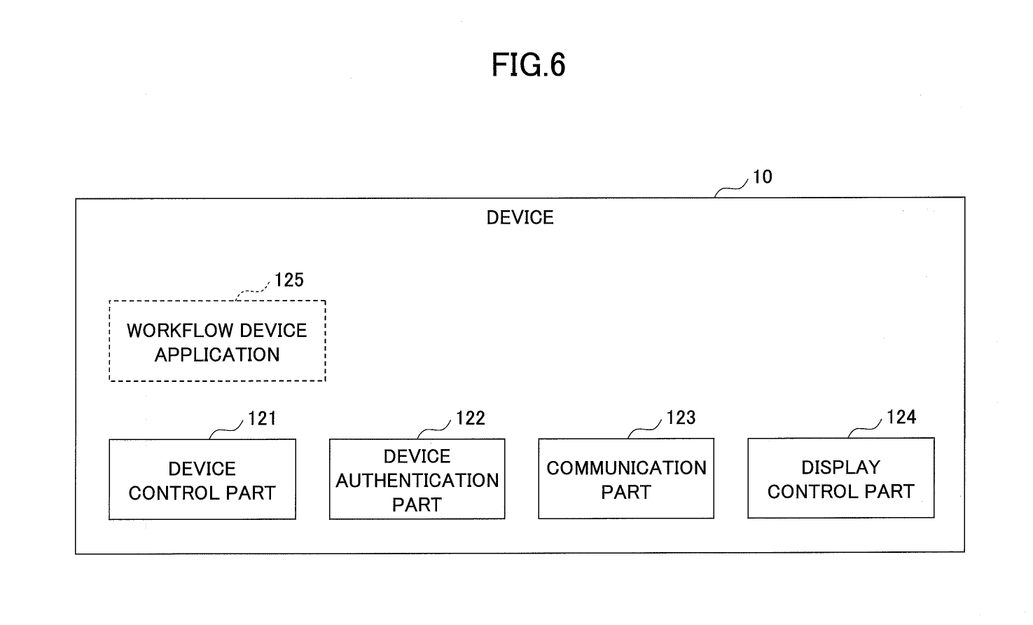

FIG. 6 illustrates an exemplary functional configuration of the device 10 according to an embodiment of the present invention. In FIG. 6, the device 10 includes a device control part 121, a device authentication part 122, a communication part 123, and a display control part 124. These functional components may be implemented by one or more programs that are installed in the device 10 and executed by the CPU 111, for example.

The device control part 121 controls operations of hardware components of the device 10. The device authentication part 122 executes a process for authenticating the operator (user) of the device 10. The communication part 123 controls communication established via a network. The display control part 124 controls display operations such as screen display operations of the display unit of the operations panel 15, for example.

In FIG. 6, the workflow device application 125 is illustrated by a broken line. The workflow device application 125 is an example of a device application that is installed in the device 10 to enable the device 10 to cooperate with the service providing apparatus 20 upon implementing a workflow service provided by the service providing apparatus 20. The device application may be any form of application program that may be installed in the device 10. For example, an application program that may also function as a server application may be installed in the device 10 as the device application.

In the present embodiment, the workflow device application 125 is not installed in the device 10 from the start. Rather, the workflow device application 125 is installed in the device 10 during preparatory operations for enabling use of a workflow service. For this reason, the workflow device application 125 is illustrated by a broken line in FIG. 6. However, in alternative embodiments, the workflow device application 125 may be installed in the device 10 from the start.

In the following, processes executed at the information processing system 1 are described.

To enable use of a workflow service within the user environment E1, preparatory operations have to be performed such as registering various items of information relating to the user environment E1 in the service providing apparatus 20 and installing the workflow device application 125 in the image forming apparatus 10a. Thus, in the following, process steps that are executed in connection with such preparatory operations are described. The preparatory operations described below may be performed by an administrator within the user environment E1 (simply referred to as “administrator” hereinafter) using the administrator terminal 30, for example.

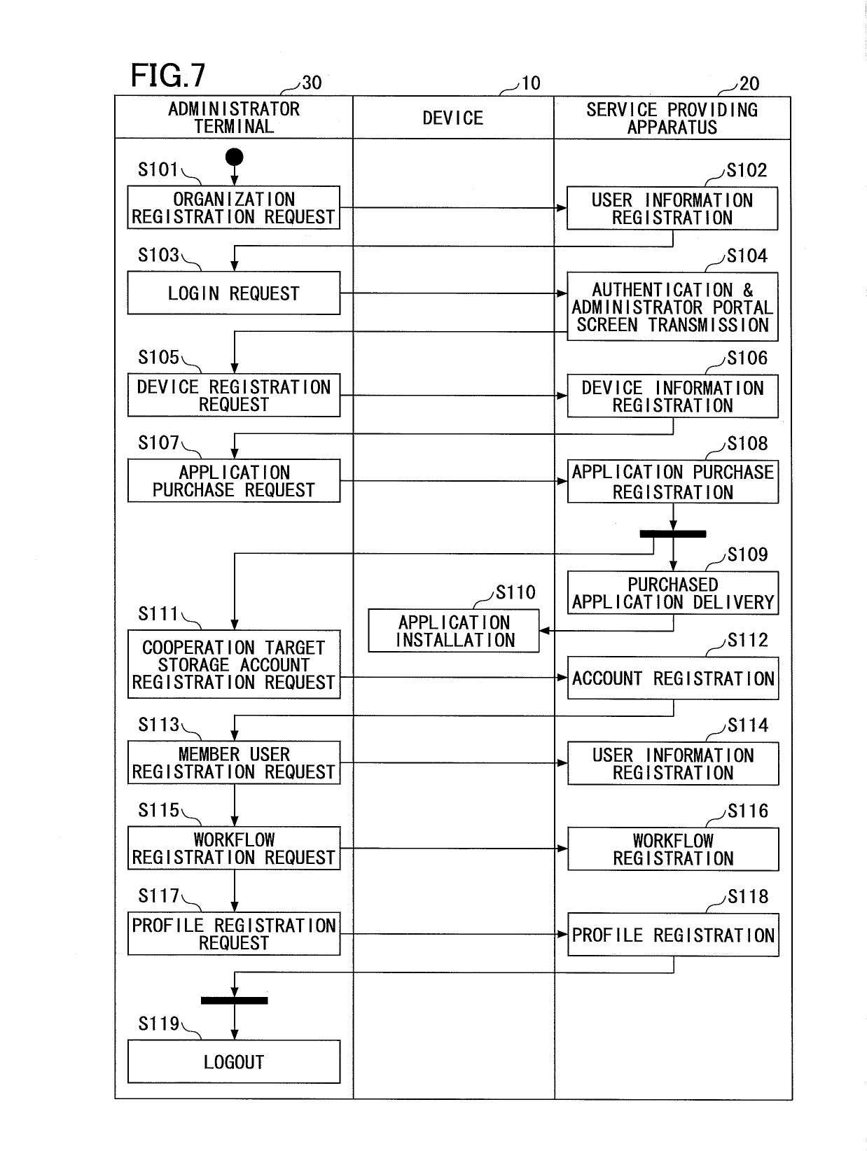

FIG. 7 illustrates exemplary process steps that are executed in connection with the preparatory operations.

In step S101, the administrator terminal 30 transmits an organization registration request to the service providing apparatus 20 in response to a command input by the administrator. The organization registration request refers to a registration request for registering information relating to an organization that is to use the service provided by the service providing apparatus 20. For example, the organization may be a single company. Alternatively, the organization may be one department within a single company. That is, in some cases, a single company may include a plurality of organizations. In the present example, it is assumed that the user environment E1 corresponds to a system environment of one organization. Note that an organization is not limited to a company or a department within a company, but may be any collective entity such as a group or a social circle. An organization may also be an entity constituting a single person, for example.

The organization registration request may be issued through operation of an operation screen as described below, for example.

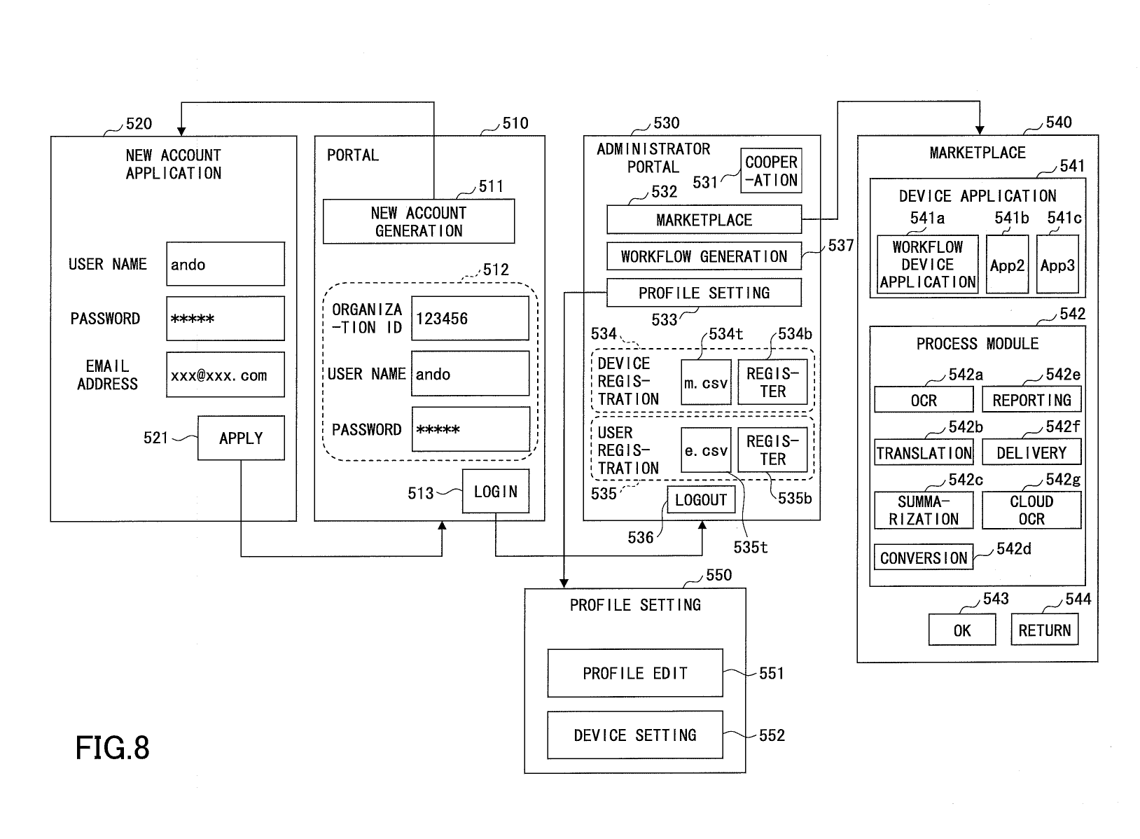

FIG. 8 illustrates exemplary screens that may be displayed at the administrator terminal 30 during the preparatory operations. In the example illustrated in FIG. 8, a portal screen 510 is displayed at the administrator terminal 30 at the start of the preparatory operations. The portal screen 510 acts as a window to the service provided by the service providing apparatus 20. Note that the various screens illustrated in FIG. 8 may be displayed based on a webpage including HTML data that is provided by the service providing apparatus 20, for example. That is, although not mentioned in the descriptions below, HTTP (HyperText Transfer Protocol) communication is established between the administrator terminal 30 and the service providing apparatus 20 when switching from one screen to another screen.

The portal screen 510 includes a new account generation button 511, a login information input area 512, and a login button 513.

To register an organization, the administrator presses the new account generation button 511. When the new account generation button 511 is pressed, a new account application screen 520 is displayed at the administrator terminal 30. Note that arrows extending from a button of one screen to another screen in FIG. 8 indicate that a screen display is switched from the one screen to the other screen when the corresponding button is pressed.

When a user name, a password, and an email address of the administrator is input to the new account application screen 520 and an apply button 521 is pressed, the administrator terminal 30 includes the input user name, password, and email address in an organization registration request and transmits the organization registration request to the service providing apparatus 20 (S101).

Referring back to FIG. 7, in step S102, when the service providing apparatus 20 receives the organization registration request from the administrator terminal 30, the setting registration part 221 registers the information included in the organization registration request in the user information storage part 231.

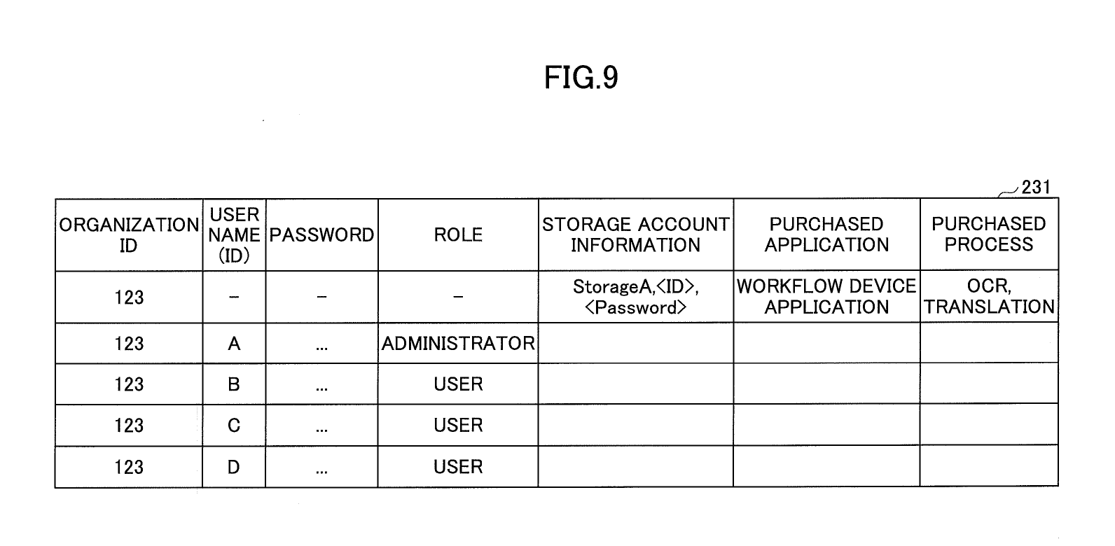

FIG. 9 illustrates an exemplary configuration of the user information storage part 231. In FIG. 9, the user information storage part 231 registers information items such as “organization ID,” “user name,” “password,” “role,” “card ID,” “storage account information,” “purchased application,” and “purchased process” for each record.

“Organization ID” refers to an identifier that is assigned to each user environment E1; namely, to each organization such as a company user that uses the service provided by the service providing apparatus 20. “User name,” “password,” “role,” and “card ID” refers to information relating to each individual user that is a constituent member of the organization identified by the organization ID (simply referred to as “member user” hereinafter).

“Role” refers to an information item for identifying the administrator among the member users. That is, a member user who is the administrator within the user environment E1 is registered as “administrator,” and member users other than the administrator are registered as “user.” “Card ID” refers to an identifier assigned to an IC card that is used by a member user upon logging into the device 10. “Storage account information” refers to account information of the cloud storage 50 used by the organization identified by the organization ID. Such account information may be used as authentication information to be presented to the cloud storage 50 upon storing image data scanned by the device 10 in the cloud storage 50. Under the information item “purchased application,” a list of one or more identifiers of applications purchased by the organization identified by the organization ID (simply referred to as “application ID” hereinafter) is registered. Under the information item “purchased process,” a list of one or more identifiers of process modules purchased by the organization identified by the organization ID (simply referred to as “module ID” hereinafter) is registered. Note that although purchased applications and process modules are identified by their names in the example illustrated in FIG. 9, in other examples, a string of numbers and/or characters may be used as an application ID or a module ID for identifying a purchased application or process module, for example.

Note that a record stored within the user information storage part 231 that does not have a user name registered corresponds to a record for the organization (user environment E1) (referred to as “organization record” hereinafter). A record having a user name registered corresponds to a record for a member user (referred to as “member record” hereinafter). In the illustrated example of FIG. 9, the information items “storage account information” “purchased application,” and “purchased process” are valid information items for an organization record. However, in other examples, the information item “storage account information” may also be valid for a member record. Note that in the following descriptions, a member record that has “administrator” registered as role information is referred to as “administrator record,” and a member record that has “user” registered as role information is referred to as “user record.”

Referring back to FIG. 7, in step S102, one organization record and one administrator record are generated. An organization ID is registered in the organization record. That is, the organization ID is assigned to the organization upon generating the organization record. Also, information items such as organization ID, user name, password, and role are registered in the administrator record. The organization ID registered in the administrator record may be the same as the organization ID registered in the organization record. The user name and password included in the organization registration request are registered as the user name and password of the administrator record. Also, “administrator” is registered as role information.

Note that other information items of the organization record and the administrator record, and additional user records may be registered or generated in processes described below.

Next, the setting registration part 221 may transmit an email indicating that the organization registration has been properly performed (referred to as “registration notification mail” hereinafter) to the email address included in the organization registration request, for example. The registration notification mail may include the organization ID that has been assigned to the organization, for example. In an alternative example, notification of the proper completion of the organization registration may be included in an HTTP response to an HTTP request that includes the organization registration request. Also, the organization ID may be designated by the administrator via the new account application screen 520, for example.

After the organization registration is properly completed, the administrator inputs the registered organization ID, user name, and password in the login information input area 512 of the portal screen 510, and presses the login button 513. In response to the pressing of the login button 513, the administrator terminal 30 transmits a login request to the service providing apparatus 20 (S103). The login request includes the organization ID, user name, and password input to the login information input area 512.

Upon receiving the login request from the administrator terminal 30, the authentication process part 223 of the service providing apparatus 20 performs user authentication of the user (administrator) making the login request. The authentication process part 223 performs the user authentication based on whether a record having the value “administrator” registered as role information and having the organization ID, user name, and password included in the login request is stored in the user information storage part 231. If such a record is stored in the user information storage part 231, the administrator may be successfully authenticated (S104). If such a record is not stored in the user information storage part 231, the authentication results in failure. When the authentication is successful, the setting registration part 221 transmits a webpage that prompts the display of a dedicated portal screen for the administrator identified by the user name included in the login request (referred to as “administrator portal screen 530” hereinafter) to the administrator terminal 30. Note that in the following descriptions, the administrator that has made the login request is referred to as “login administrator.”

The administrator terminal 30 displays the administrator portal screen 530 based on the webpage transmitted from the service providing apparatus 20.

In FIG. 8, the administrator portal screen 530 includes a cooperation button 531, a marketplace button 532, a workflow generation button 537, a profile setting button 533, a device registration area 534, and a user registration area 535.

In the illustrated example, the administrator inputs a file name in a textbox 534t of the device registration area 534 and presses a register button 534b. The input file name identifies a file describing information relating each device 10 that is to cooperate with the workflow service (such information being referred to as “device information” and such file being referred to as “device information file” hereinafter)

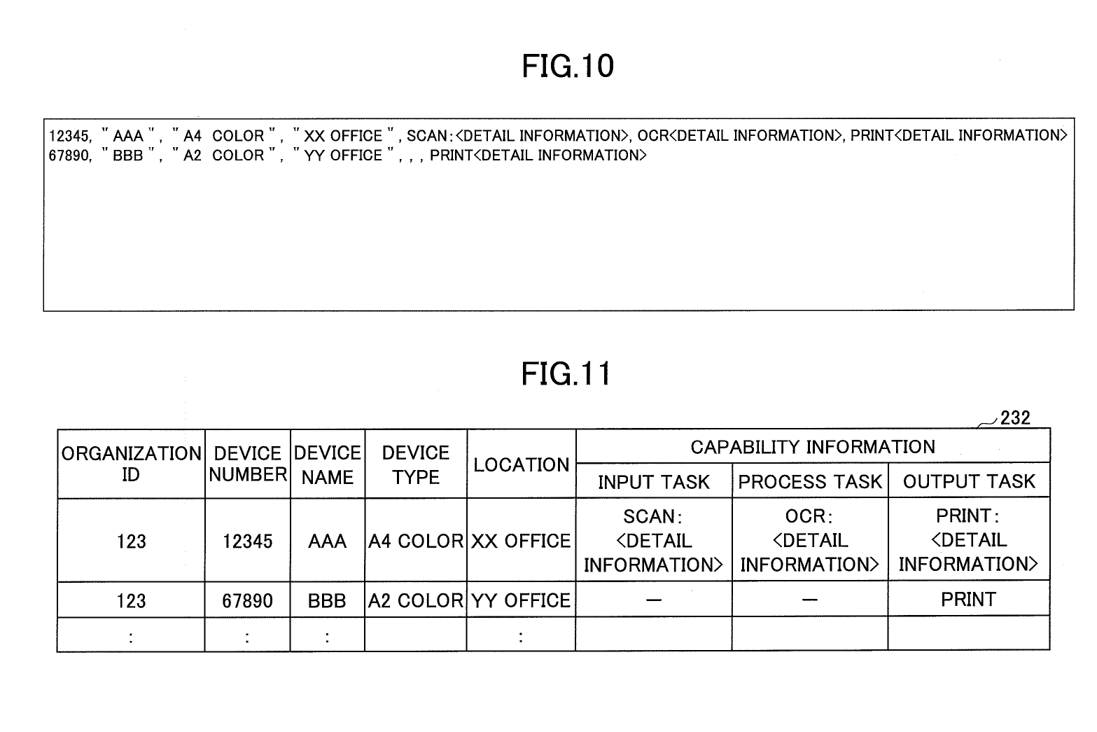

Device information of one device 10 may include information items such as device number, device name, device type, location, and capability information, for example. Values representing such information items may be described in a device information file having a format as illustrated in FIG. 10, for example.

FIG. 10 illustrates an exemplary manner of describing device information in a device information file. In the example illustrated in FIG. 10, device information is described using the CSV (Comma Separated Values) format in which the values representing the information items are separated by commas. However, the format used to describe the device information included in the device information file is not limited to the CSV format, but may be some other format such as the XML (eXtensible Markup Language) format, for example.

The device number is unique identification information for identifying each individual device 10. For example, a manufacturing number or a serial number may be used as the device number. The device name may be synonymous with model name. The device type is information succinctly describing a feature of the corresponding model. The location describes where the device 10 is located within the user environment E1. The capability information included in the device information file is described in detail below.

Referring back to FIGS. 7 and 8, when the file name of a device information file is input to the textbox 534t and the register button 534b is pressed by the administrator, the administrator terminal 30 transmits a device registration request including the device information described in the device information file to the service providing apparatus 20 (S105).

Upon receiving the device registration request from the administrator terminal 30, the setting registration part 221 of the service providing apparatus 20 registers the device information included in the device registration request in the device information storage part 232 in association with the organization ID of the organization of the login administrator (S106).

FIG. 11 illustrates an exemplary configuration of the device information storage part 232. In FIG. 11, the device information storage part 232 stores a record for each registered device 10. Each record includes information items such as “organization ID,” “device number,” “device name,” “device type,” “location,” and “capability information,” for example. The association of each device 10 with its corresponding organization is stored in the device information storage part 232.

“Capability information” refers to information indicating the capabilities of a device 10 with respect to an input task, a process task, and an output task. For example, the capability information illustrated in FIG. 11 indicates that the device 10 with the device number “12345” has the capability to execute a “scan” process as an input task, the capability to execute an “OCR” process as a process task, and the capability to execute a “print” process as an output task. Also, the capability information of FIG. 11 indicates that the device 10 with the device number “67890” has the capability to execute a “print” process as an output task.

Also, in FIG. 11, the item “detail information” indicated after each of the capability information items “scan,” “OCR,” and “print” followed by a colon “:” represent detail information relating to the scan, OCR, or print capability of the device 10. For example, detail information of the scan capability may include information on scan attributes (e.g., resolution, document size, and color mode) that may be set up and the data format of output data. Detail information of the OCR capability may include information on compatible languages, compatible data formats for input data, and the data format of output data, for example. Detail information of the print capability may include print attributes (e.g., color mode, paper size, single/dual side, combining) that may be set up and the data format of input data, for example.

Note that registration of the device information in step S105 may be performed by the device 10 with the corresponding device information, for example.

Next, referring back to FIGS. 7 and 8, the administrator presses the marketplace button 532 of the administrator portal screen 530 to purchase the workflow device application 125 and process modules corresponding to process tasks to be used in the workflow that need to be installed in the device 10 before the workflow service may be used. When the marketplace button 532 is pressed by the administrator, the administrator terminal 30 displays a marketplace screen 540.

As illustrated in FIG. 8, the marketplace screen 540 includes selection buttons (or icons) corresponding to the device applications and the process modules stored in the device application storage part 233. In the example illustrated in FIG. 8, three selection buttons 541a-541c corresponding to three device applications are included in a device application selection area 541. Of these three selection buttons 541a-541c, the selection button 541a is for selecting the workflow device application 125. Also, the marketplace screen 540 displays a process module selection area 542 including selection buttons 542a-542g corresponding to the process modules 2271-2277 illustrated in FIG. 5.

Because the workflow device application 125 is to be purchased in the present example, the administrator selects the corresponding button 541a. Also, the administrator selects selection buttons corresponding to process modules that are required in the workflow to be generated. Note that in the present example, the marketplace screen 540 is configured to enable selection of multiple selection buttons at the same time.

When the selection buttons are selected and an OK button 543 is pressed, the administrator terminal 30 transmits a program purchase request including the application ID of the workflow device application 125 and the module IDs of the process modules corresponding to the selection buttons selected at the process module selection area 542 to the service providing apparatus 20 (S107).

Upon receiving the program purchase request from the administrator terminal 30, the setting registration part 221 of the service providing apparatus 20 registers the application ID and the module IDs included in the program purchase request in the corresponding organization record within the user information storage part 231 (S108). That is, the setting registration part 221 stores the application ID under “purchased application” and stores the module IDs under “purchased process” of the organization record with the organization ID identifying the organization with which the login administrator is associated. For example, in the user information storage part 231 illustrated in FIG. 9, “workflow device application” is registered under the item “purchased application,” and “OCR” and “translation” are registered under the item “purchased process” of the organization record with the organization ID “123” at this time (i.e., in step S108).

Next, the device communication part 222 obtains the workflow device application 125, which corresponds to the device application identified by the application ID included in the program purchase request, from the device application storage part 233, and delivers the obtained workflow device application 125 to the device 10 associated with the organization ID of the login administrator that has issued the application purchase request (S109). The device 10 associated with the organization ID of the login administrator refers to the device 10 that is registered in the device information storage part 232 in association with the organization ID of the organization to which the login administrator belongs.

Note that a firewall is typically implemented at the user environment E1 and the firewall may prevent the service providing apparatus 20 from delivering the workflow device application 125 to the devices 10 within the user environment E1. Accordingly, in certain embodiments, the service providing apparatus 20 may transmit the workflow device application 125 to the device 10 in response to a polling request from the communication part 123 of the device 10.

The device 10 may retain information such as the IP address of the service providing apparatus 20 and a port number of the device communication part 222, for example, so that the device 10 may cooperate with the service providing apparatus 20. For example, the communication part 123 of the device 10 may conduct polling by periodically sending inquiries to the IP address and the port number to check whether some event has occurred. The inquiry may include the device number of the device 10, for example. If the device number designated in the inquiry corresponds to the device number of the device 10 associated with the organization ID of the login administrator that has issued the application purchase request for the workflow device application 125, the device communication part 222 of the service providing apparatus 20 transmits the workflow device application 125 to the device 10 in response to its inquiry.

On the other hand, in a case where no firewall is implemented between the user environment E1 and the service providing apparatus 20, the device communication part 222 may simply transmit the workflow device application 125 to the devices 10 within the user environment E1. In this case, the IP address and the port number of the devices 10 may be included in the device information stored in the device information storage part 232.

In the present embodiment, the process modules are not delivered to the devices 10 because the process modules are programs for prompting the service providing apparatus 20 to execute predetermined processes. Accordingly, in the present embodiment, purchasing the process modules simply means purchasing the license to use the process modules.

Upon receiving the workflow device application 125 from the communication part 222, the devices 10 install the received workflow device application 125 (S110).

Next, when the administrator presses the OK button 543 of the marketplace screen 540 that is displayed at the administrator terminal 30, the marketplace screen 540 is hidden and the administrator portal screen 530 is displayed at the administrator terminal 30.

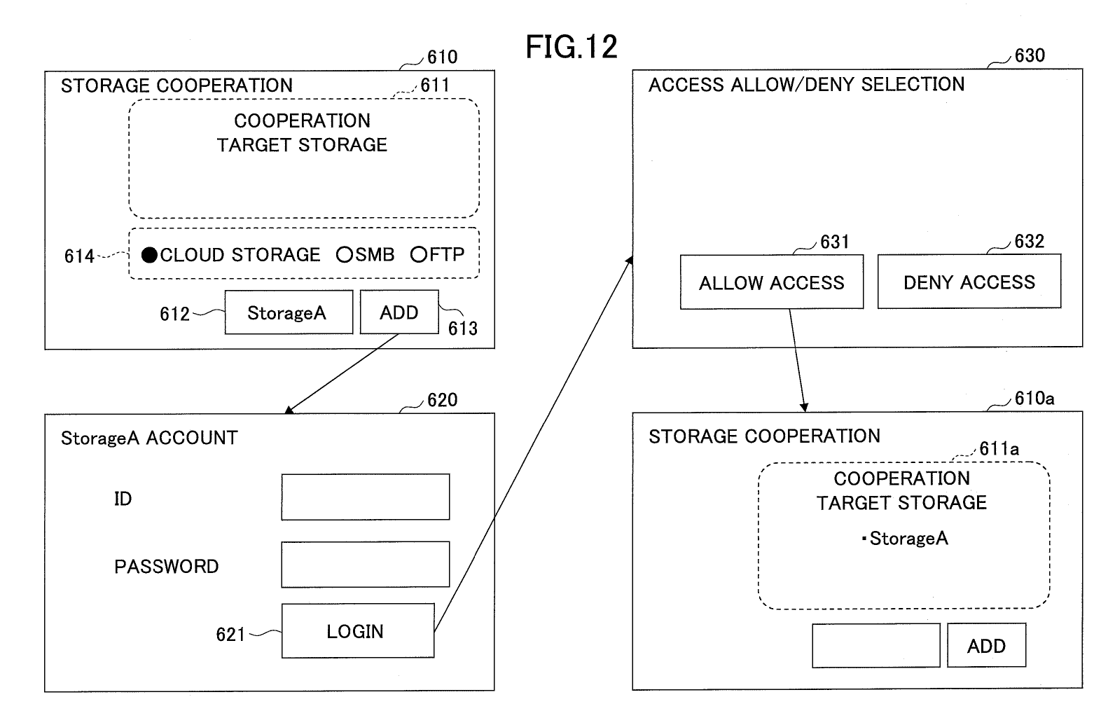

Next, the administrator presses the cooperation button 531 of the administrator portal screen 530 to register account information of the cloud storage 50 that is to be used in cooperation with the workflow service. When the cooperation button 531 is pressed by the administrator, the administrator terminal 30 displays a storage cooperation screen 610 (e.g., FIG. 12).

FIG. 12 illustrates exemplary screens for registering account information of a storage that is to cooperate with the workflow service.

In FIG. 12, the storage cooperation screen 610 includes a cooperation target storage display area 611, a cooperation target input area 612, a storage type selection area 614, and an add button 613. The cooperation target storage display area 611 displays the name of a storage that has been designated as the cooperation target storage (referred to as “storage name” hereinafter). If one or more storages have already been designated as cooperation target storages, the storage names of the designated storages are displayed at the cooperation target storage display area 611. The cooperation target input area 612 is for inputting the storage name of the storage to be designated as a cooperation target (referred to as “cooperation target storage” hereinafter). The storage type selection area 614 is an area for selecting the type of the storage designated as the cooperation target via a radio button, for example. In the illustrated example of FIG. 12, “cloud storage,” “SMB,” and “FTP” are provided as storage type options that may be selected. The cloud storage 50 of the present embodiment may be classified under “cloud storage.” That is, “cloud storage” represents a storage provided outside the user environment E1. “SMB” represents a local storage that may be accessed using SMB (Server Message Block). “FTP” represents a local storage that may be accessed using FTP (File Transfer Protocol). The local storage 40 may be classified under either “SMB” or “FTP.”

When the administrator selects “cloud storage” as the storage type, inputs a storage name (“Storage A”) in the cooperation target input area 612, and presses the add button 613, the administrator terminal 30 displays an account input screen 620. The administrator terminal 30 accepts, via the account input screen 620, an input of account information of the cooperation target storage (e.g., an ID such as an email address and a password) from the administrator. The account information may be generated beforehand during a user registration process for registering as a user of the cooperation target storage, for example. When the ID and password are input to the account input screen 620 and a login button 621 is pressed, the administrator terminal 30 logs into the cooperation target storage (“Storage A”) using the input ID and password. In certain embodiments, a URL (Uniform Resource Locator) of a login request destination for the cooperation target storage may be stored in the administrator terminal 30 in association with the storage name. Alternatively, the URL may be input via the cooperation target input area 612.

If the login operation is successful, the administrator terminal 30 displays an access allow/deny selection screen 630. The access allow/deny selection screen 630 enables the administrator to select whether to allow or deny the service providing apparatus 20 access to the cooperation target storage. If a button 632 (“deny access”) is pressed, the display screen of the administrator terminal 30 switches back to the administrator portal screen 530. If a button 631 (“allow access”) is pressed, the administrator terminal 30 transmits an account registration request for registering the cooperation target storage with the service providing apparatus 20 (S111). The account registration request may include the storage name input to the storage cooperation screen 610, and the account information (e.g., ID and password) input to the account input screen 620.

Upon receiving the account registration request from the administrator terminal 30, the setting registration part 221 of the service providing apparatus 20 registers the storage name, ID, and password included in the account registration request as storage account information of the organization record with the organization ID of the login administrator stored in the user information storage part 231 (S112). For example, in FIG. 9, the storage name “Storage A,” and the ID and password used in connection with Storage A are registered in the organization record for the organization with the organization ID “123.”

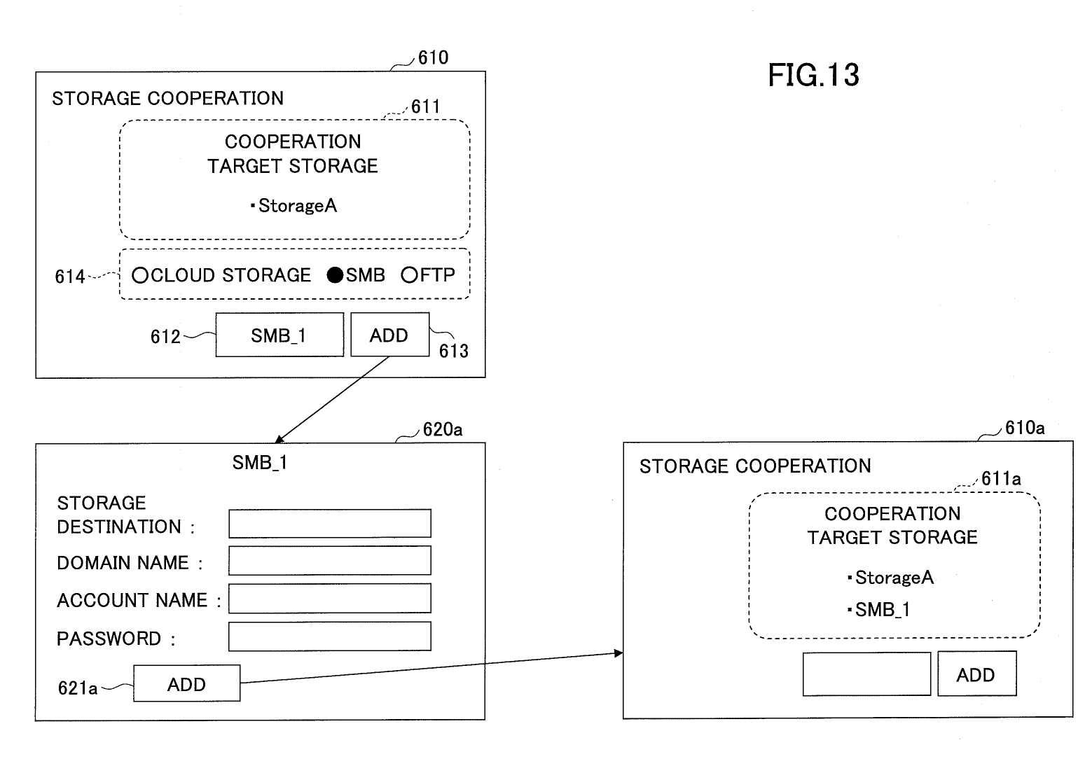

On the other hand, when “SBM” is selected as the storage type at the storage cooperation screen 610, screens as illustrated in FIG. 13 may be displayed, for example.

FIG. 13 illustrates another set of exemplary screens for registering account information of a cooperation target storage. Note that the storage cooperation screen 610 illustrated in FIG. 13 indicates that “Storage A” is already registered as a cooperation target storage.

When “SMB” is selected by the administrator as the storage type and a storage name (e.g., “SMB_1”) is input to the cooperation target input area 612 after which the add button 613 is pressed, the administrator terminal 30 displays an SMB account input screen 620a as illustrated in FIG. 13.

The SMB account input screen 620a accepts inputs of a storage destination, a domain name, an account name, and a password. The storage destination corresponds to identification information of the local storage to be accessed using SMB. The identification information may be a host name, an IP address, or any type of information that enables identification of the storage destination under SMB. The domain name, account name, and password correspond to required account information for accessing the local storage. When “FTP” is selected by the administrator as the storage type, an FTP account input screen (not shown) may be displayed instead of the SMB account input screen 620a. The FTP account information input screen may be configured to accept an IP address of the local storage to be accessed using FTP and required account information for accessing the local storage.

When an IP address, a domain name, an account name, and a password are input to the SMB account input screen 620a, and an add button 621a is pressed, the administrator terminal 30 transmits an account registration request for registering the cooperation target storage to the service providing apparatus 20 (S111 of FIG. 7). The account registration request includes the storage name input to the storage cooperation screen 610 and the account information input to the SMB account input screen 620a (IP address, domain name, account name, password, etc.).

Upon receiving the account registration request, the setting registration part 221 of the service providing apparatus 20 registers the storage name, the IP address, the domain name, the account name, and the password included in the account registration request as storage account information of the organization record that is stored in association with the organization ID of the login administrator within the user information storage part 231 (S112 of FIG. 7).

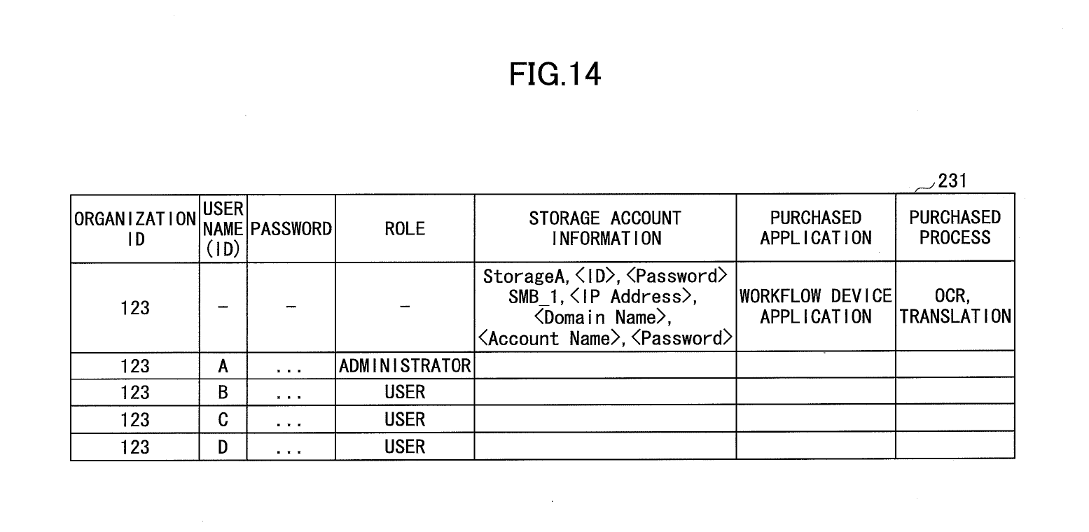

FIG. 14 illustrates an example in which storage account information is added to the user information storage part 231. In the example illustrated in FIG. 14, account information of the storage “SB_1” is registered in the second line of the storage account information of the organization record for the organization identified by the organization ID “123.”

In certain embodiments, the cooperation target storage and the account information of the cooperation target storage may be registered for each member user. In this case, the storage cooperation screen 610 or the account input screen 620 may include an input area for inputting one or more user names, for example. The one or more user names input to such input area may be included in the account registration request that is transmitted to the service providing apparatus 20. In turn, the setting registration part 221 of the service providing apparatus 20 may register the storage name, ID, and password included in the account registration request as account information of the member record for the member user identified by the user name included in the account registration request.

If the registration process based on the account registration request is successfully performed at the service providing apparatus 20, the administrator terminal 30 may display a storage cooperation screen 610a as illustrated in FIGS. 12 and 13, for example. The storage cooperation screen 610a includes a cooperation target storage display area 611a that displays the storage name (e.g., “Storage A”, “SMB_1”) of the cooperation target storage that has been successfully registered in the service providing apparatus 20.

Next, the administrator registers one or more member users within the user environment E1 that are to be authorized to use the workflow service. Specifically, in the administrator portal screen 530 illustrated in FIG. 8, the administrator inputs the file name of a file describing information relating to such member users (referred to as “user information” hereinafter) in a textbox 535t included in the user registration area 535 and presses a register button 535b.

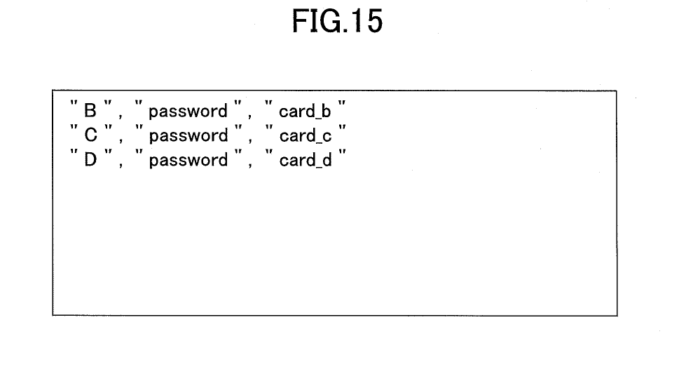

User information of one member user may include information items such as a user name, a password, and a card ID. Values representing such information items may be described in a user information file according to a certain format such as that illustrated in FIG. 15, for example.

FIG. 15 illustrates an exemplary manner of describing user information within a user information file. In the example illustrated in FIG. 15, the CSV format, which separates values representing various information items by commas, is used to describe the user information. However, the format used to describe the user information within the user information file is not limited to the CSV format but may be any other suitable format such as the XML format.

When the file name of the user information file is input to the textbox 535t and the register button 535b is pressed by the administrator, the administrator terminal 30 transmits a user registration request including the user information described in the user information file to the service providing apparatus 20 (S113 of FIG. 7).

Upon receiving the user registration request from the administrator terminal 30, the setting registration part 221 of the service providing apparatus 20 registers the user information included in the user registration request in the user information storage part 231 in association with the organization ID of the organization to which the login administrator belongs (S114 of FIG. 7). Specifically, a new user record is generated for each set of user information, and each user record has one set of user information registered therein. For example, in FIG. 9, a user record may be generated and registered for each of user names B, C, and D in step S114. In certain embodiments, user information relating to the administrator may be included in the user registration request. User information relating to the administrator refers to user information relating to the user name included in the administrator record. In this case, the administrator record may be updated based on the user information relating to the administrator that is included in the user registration request. For example, the card ID of the administrator may be registered in the administrator record at this time (in step S114).

Next, the administrator generates a definition of a workflow. When the workflow definition generation button 537 displayed at the administrator portal screen 530 (FIG. 8) is pressed, the administrator terminal 30 displays a workflow generation screen.

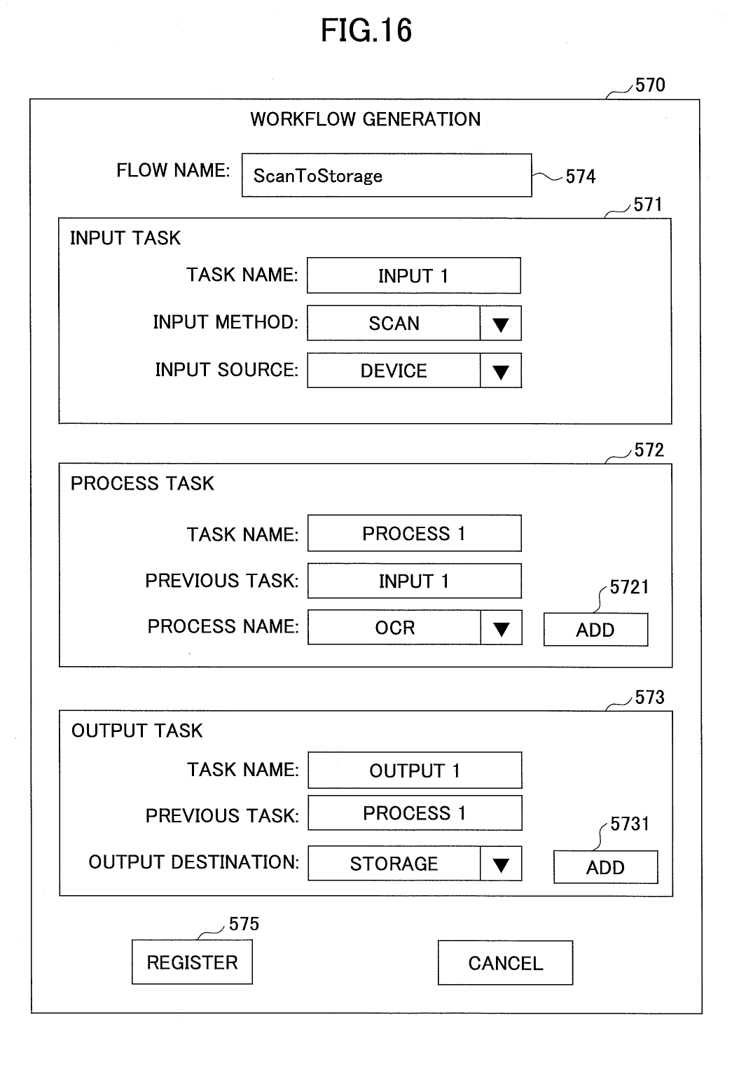

FIG. 16 illustrates an exemplary workflow generation screen 570. As illustrated in FIG. 16, the workflow generation screen 570 includes a flow name setting area 574, an input task setting area 571, a process task setting are 572, and an output task setting area 573.

The flow name setting area 574 is an area for setting up the name of the workflow to be generated (referred to as “flow name”) hereinafter. In the example illustrated in FIG. 16, “ScanToStorage” is indicated as the flow name.

The input task setting area 571 is an area for setting up information such as a task name, an input method, and an input source relating to an input task. The task name refers to a name for identifying each task. For example, an administrator may assign an arbitrary value as the task name of each task. The input method refers to a data input method. For example, either “scan” or “upload” may be selected as the input method. “Scan” refers to inputting data by scanning image data with a scanner.

“Upload” refers to inputting data by uploading the data via a. network (receiving data via a network as viewed from the service providing apparatus 20).

The input source refers to the source from which data is input. For example, “device,” “storage,” “web,” “HTTP POST,” or “mail” may be selected as the input source. “Device” may be a valid input source option when “scan” is selected as the input method. That is, of the above input source options, only the device 10 (image forming apparatus 10a) has the capability of executing a scan process. “Storage,” “web,” “HTTP POST,” and “mail” may be valid input source options when “upload” is selected as the input method. “Storage” refers to any one of the local storage 40, the cloud storage 50, or the server storage 237.

When “storage” is selected as the input source, data uploaded in a predetermined file of one of the local storage 40, the cloud storage 50, or the server storage 237 is subject to the input process of the input task. “Web” refers to uploading data to a predetermined URL via a webpage provided by the service providing apparatus 20. “HTTP POST” refers to uploading data to a predetermined URL using HTTP POST. Note that the URL corresponding to the upload destination when using HTTP POST may be the same as the predetermined URL to which data is uploaded via a webpage when “web” is selected. In this case, uploading data using “HTTP POST” differs from uploading via a “web” in that “HTTP POST” does not require a “HTTP POST” GUI (graphic user interface) corresponding to a webpage. That is, by using “HTTP POST,” automatic uploading may be enabled without requiring interactive operations with a user. For example, “HTTP POST” may be used in a case where the PC 10h monitors a predetermined folder of a file system within the PC 10h and uploads data transferred to the folder from the digital cameral 10e or the mobile terminal 10g using HTTP POST. “Mail” refers to uploading data using an email addressed to a predetermined email address.

Note that when “web,” “HTTP POST,” or “mail” is selected as the input source, a special program such a device application does not have to be installed in the device 10 that is to transmit data according to the designated communication method. That is, the device 10 corresponding to the data transmission source in this case simply requires a standard program for establishing communication according to the corresponding communication protocol.

The process task setting area 572 is an area for setting up information such as task name, previous task, and process name relating to a process task. As described above task name refers to a name for identifying each task. Previous task refers to a task preceding (connected to the input side of) the process task subject to setting in the process task setting area 572. In FIG. 16, the task name of the input task “input 1” is indicated as the previous task. This means that the process task with the task name “process 1” subject to setting in the process task setting area 572 is to be executed right after the input task with the task name “input 1” is executed. Process name refers to the name of the process that is to be executed by the process task subject to setting in the process task setting area 572. The process name may be selected from the process names corresponding to module IDs stored in the user information storage part 231 (FIG. 9) under the item “purchased process” for the organization ID of the login administrator, and/or the process names stored in the device information storage part 232 (FIG. 11) in association with the organization ID as capability information with respect to a process task, for example. In the present example, either “OCR” or “translation” may be selected as the process name. Note that the process names corresponding to the module IDs may be determined based on attribute information of each process module stored in the auxiliary storage device 202, for example. That is, the attribute information of each process module may include information items such as module ID, process name, and interface information such as input information and output information, for example.

The process task setting area 572 also includes an add button 5721. When the add button 5721 is pressed, the administrator terminal 30 adds a new process task setting area 572 below the currently displayed process task setting area 572 (the process task setting area 572 with the add button 5721 that has been pressed). In this way, a workflow including multiple process tasks may be generated.

The output task setting area 573 is an area for setting up information such as task name, previous task, and output destination relating to the output task. Task name and previous task are described above. Output destination refers to the data output destination for the output task. For example, “device” or “storage” may be selected as the output destination.

The output task setting area 573 also includes an add button 5731. When the add button 5731 is pressed, the administrator terminal 30 adds a new output task setting area 573 below the currently displayed output task setting area 573 (the output task setting area 573 with the add button 5731 that has been pressed). In this way, a workflow including multiple output tasks may be generated.

When necessary setting/editing operations on the workflow generation screen 570 are completed and a register button 575 is pressed, the administrator terminal 30 transmits a workflow registration request including the settings/edits made at the workflow generation screen 570 to the service providing apparatus 20 (S115 of FIG. 7). Upon receiving the workflow registration request from the administrator terminal 30, the setting registration part 221 of the service providing apparatus 20 registers the information included in the workflow registration request in the workflow definition storage part 236 (S116 of FIG. 7).

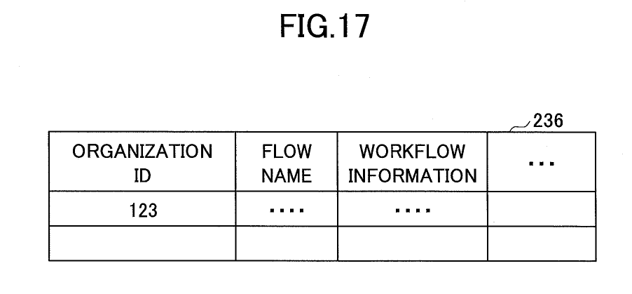

FIG. 17 illustrates an exemplary configuration of the workflow definition storage part 236. In FIG. 17, the workflow definition storage part 236 includes information items such as “organization ID,” “flow name,” and “workflow information.”

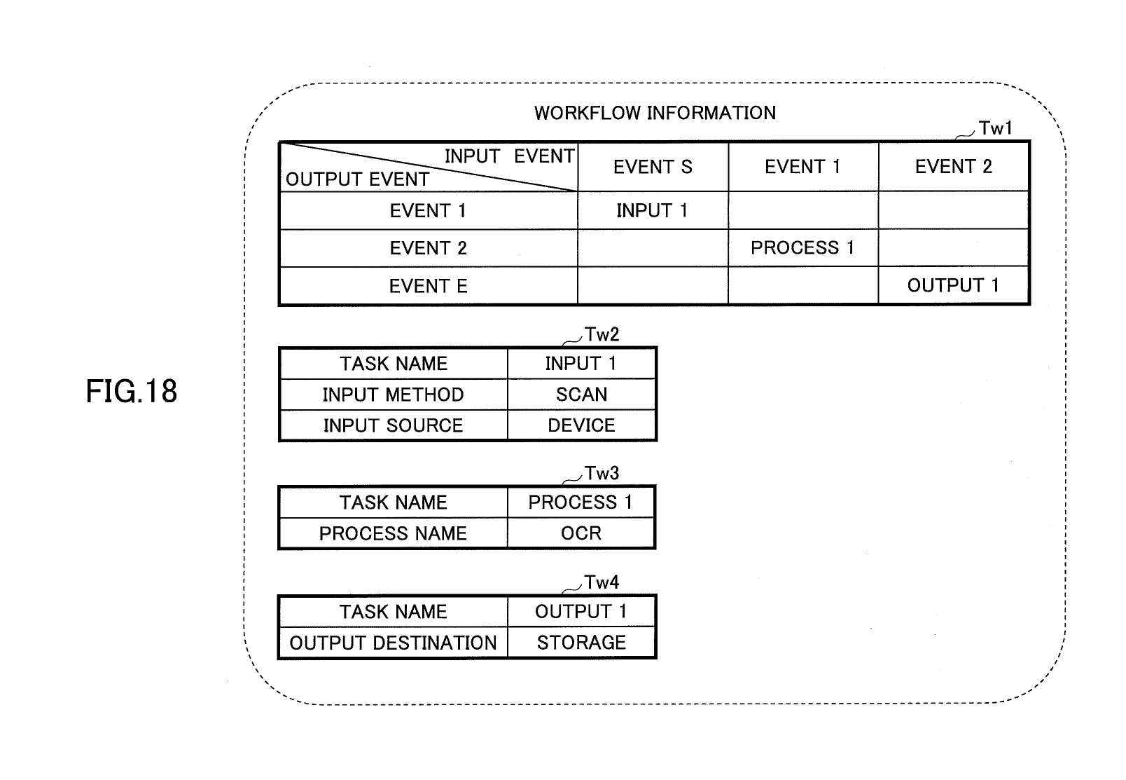

“Organization ID” refers to the organization ID of the organization that applies the definition of the workflow. “Flow name” refers to the name of the workflow. “Workflow information” corresponds to information indicating a definition of the workflow (also referred to as “workflow definition information” hereinafter). In step S116 of FIG. 7, the organization ID of the organization of the login administrator is stored as the organization ID in the workflow definition storage part 236. Also, a value set up in the flow name setting area 574 of the workflow generation screen 570 is stored as the flow name in the workflow definition storage part 236. The workflow information stored in the workflow definition storage part 236 is described below with reference to FIG. 18.

FIG. 18 illustrates an exemplary configuration of workflow information. The workflow information configuration illustrated in FIG. 18 corresponds to that for one workflow. Note that the workflow information indicated in FIG. 18 corresponds to the settings indicated in the workflow generation screen 570 of FIG. 16.

The workflow information of FIG. 18 includes a flow definition table tw1, an input task table Tw2, a process task table Tw3, and an output task table Tw4.

The flow definition table tw1 stores information relating to the connection between the tasks making up the workflow (i.e., execution order of the tasks). In the present example, tasks are connected by a concept called “event.” Note that “event” simply refers to identification information for identifying a connection between tasks and does not necessarily describe some specific event.

That is, in the flow definition table Tw1, the task name of each task is associated with a corresponding input event and output event. “Input event” refers to identification information on the input side. “Output event” refers to identification information on the output side. When the value of an input event associated with a given task matches the value of an output event associated with another task, this indicates that the given task is to be executed after the other task is executed.

For example, with respect to a task identified by the task name “input 1” (referred to as “task [input 1]” hereinafter, the same notation being used for the other task names as well), the corresponding input event of task [input 1] is “event S” and the corresponding output event of task [input 1] is “event 1.” The corresponding input event of task [process 1] is “event 1” and the corresponding output event of task [process 1] is “event 2.” The corresponding input event of task [output 1] is “event 2” and the corresponding output event of task [output 1] is “event E.” In this example, the input event of task [process 1] matches the output event of task [input 1]. Accordingly, task [process 1] is to be executed after task [input 1]. Also, the input event of task [output 1] matches the output event of task [process 1]. Accordingly, task [output 1] is to be executed after task [process 1]. As can be appreciated, the flow definition table tw1 indicates that the tasks of the workflow are to be executed in the following order: task [input 1]→task [process 1]→task [output 1]. Note that “event S” represents the start of the workflow, and “event E” represents the end of the workflow.

The information content stored in the flow definition table tw1 is based on the task names of the input task, process task, and output task designated in the workflow generation screen 570 of FIG. 16; and task names designated as “previous task” in the process task setting area 572 and the output task setting area 573. The names of the events connecting the tasks may be automatically generated by the setting registration part 221, for example.

The input task table Tw2 stores the task name, task type, input method and input source of task [input 1]. The information content stored in the input task table Tw2 is based on the settings made at the input task setting area 571 of the workflow generation screen 570.

The process task table Tw3 stores the task name and process name of task [process 1] corresponding to a process task of the workflow. The information content stored in the process task table Tw2 is based on the settings made at the process task setting area 572 of the workflow generation screen 570.

The output task table Tw4 stores the task name and output destination of task [output 1] corresponding to the output task of the workflow. The information content stored in the output task table Tw4 is based on the settings made at the output task setting area 573 of the workflow generation screen 570.

Note that steps S115 and S116 of FIG. 7 may be repetitively executed to register multiple workflow definitions in the workflow definition storage part 236.

Next, the administrator may perform editing operations and/or setting operations with respect to a profile that includes configuration information of an operation screen to be displayed at a display unit of each device 10 (e.g., the operation panel 15 of the image forming apparatus 10a) upon using the workflow service. In the present embodiment, the profile includes configuration information of an operation screen of the workflow device application 125. The profile may include information relating to the layout of buttons on the operation screen, and information relating to the individual buttons such as setting information of the workflow, for example.

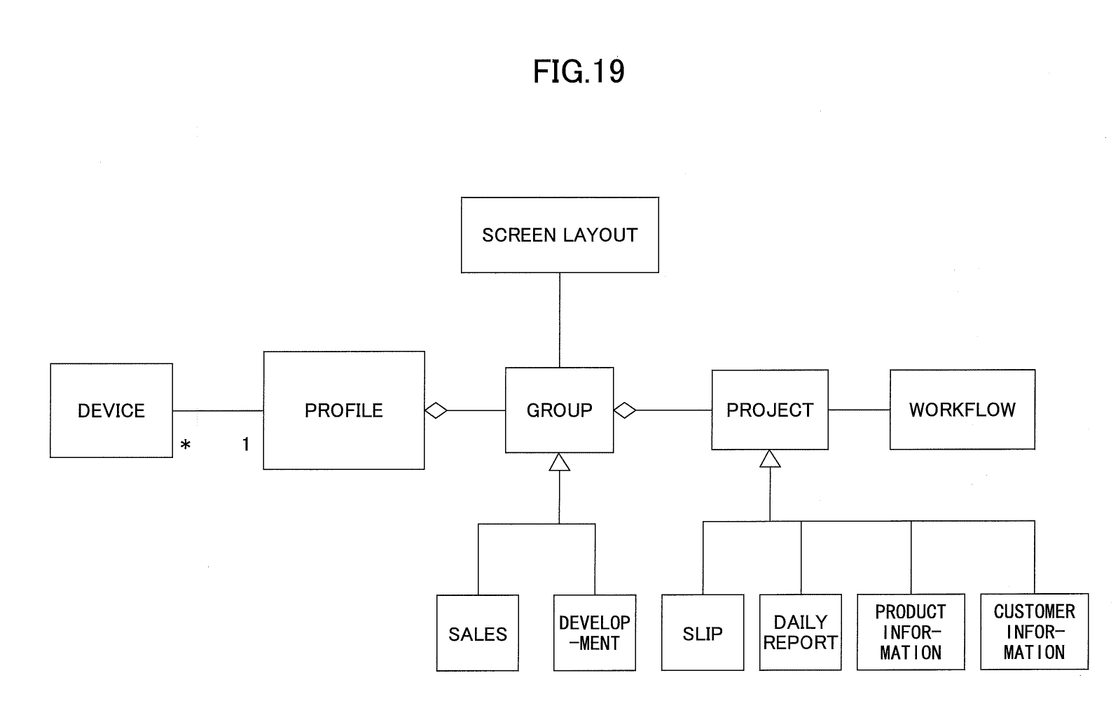

FIG. 19 illustrates a conceptual model of a profile. In FIG. 19, each device 10 has one profile. In certain embodiments, a different profile may be set up for each individual device 10, or a different profile may be set up for each user with respect to one device 10.

The profile includes at least one group. A group may be a concept associated with a tab window within an operation screen, for example. In FIG. 19, “sales” and “development” are illustrated as specific examples of groups. These groups represent a sales tab window and a development tab window, respectively.

One group includes at least one project and at least one set of screen layout information. A project may be a concept associated with an operation component such as a button arranged on a tab window, for example. In FIG. 19, “slip,” “daily report,” “product information,” and “customer information” are illustrated as specific examples of projects. The projects may represent the labels on buttons arranged at the sales tab window, for example.

The screen layout information may include information on the layout and size of operation components (buttons) arranged within a tab window, for example.

In the present embodiment, each project is associated with one workflow. That is, a workflow to be executed may be selected through selection of a button displayed at a tab window, for example.

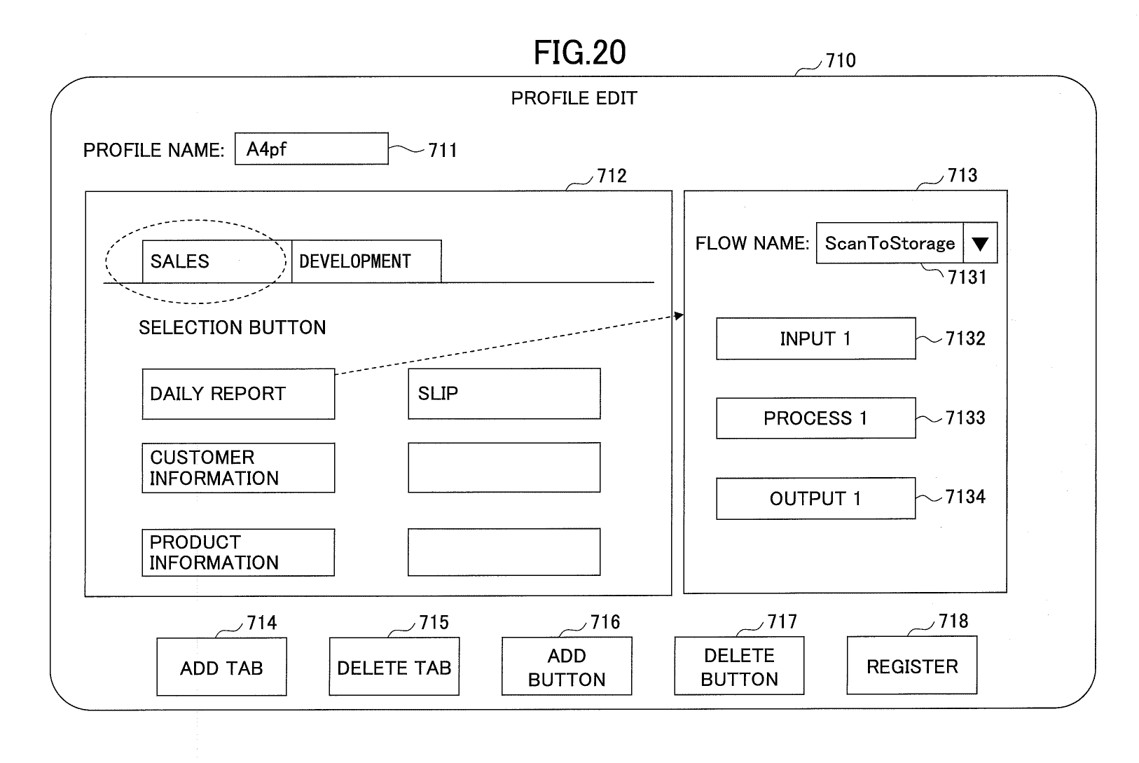

Referring back to FIG. 8, when the profile setting button 533 of the administrator portal screen 530 is pressed, the administrator terminal 30 displays a profile setting screen 550. As illustrated in FIG. 8, the profile setting screen 550 includes a profile edit button 551 and a device setting button 552. When the profile edit button 551 is selected by the administrator, the administrator terminal 30 displays a profile edit screen 710 (e.g., FIG. 20) within the profile setting screen 550.

FIG. 20 illustrates an exemplary display of the profile edit screen 710. In FIG. 20, the profile edit screen 710 includes a profile name input area 711, an edit target screen display area 712, a workflow setting area 713, edit buttons 714-717, and a register button 718.

The profile name input area 711 is for accepting an input of a profile name. The edit target screen display area 712 displays an operation screen that is subject to editing (operation screen of the workflow device application 125). In FIG. 20, an exemplary screen corresponding to the conceptual model illustrated in FIG. 19 is displayed at the edit target screen display area 712. That is, the edit target screen displayed in FIG. 20 includes a sales tab window and a development tab window, with the sales tab window including a daily report button, a customer information button, a product information button, and a slip button as selection buttons.

The edit buttons 714-717 are buttons used for adding a new tab window, deleting a tab window that is subject to editing, adding a button to the tab window that is subject to editing, and deleting a selected button included in the tab window that is subject to editing.

Note that an initial screen displayed at the edit target screen display area 712 may be a screen having one tab window and one button arranged therein, for example. Alternatively, a screen based on a predetermined profile that is generated beforehand as a base pattern may be displayed as the initial screen.

A button selected at the edit target screen display area 712 (referred to as “target button” hereinafter) may be subject to deletion by the edit button 717 (“delete button”) or setting operations at the workflow setting area 713. The workflow setting area 713 may include a list box 7131 and buttons 7132-7134 corresponding to the tasks making up the workflow whose flow name is selected at the list box 7131, for example.

The list box 7131 displays a list of flow names that are stored in the workflow definition storage part 236 in association with the organization ID of the organization of the login administrator. When a flow name is selected from the list box 7131, the workflow setting area 713 is configured to display a button corresponding to each task making up the workflow whose flow name is selected at the list box 713 (referred to as “target workflow” hereinafter). In the example illustrated in FIG. 20, the flow name “ScanToStorage” is selected at the list box 7131. Accordingly, buttons 7131-7134 respectively corresponding to task [input 1], task [process 1], and task [output 1] of the target workflow (ScanToStorage workflow) are displayed.

When one of the buttons 7132-7134 is selected, a corresponding task setting screen is displayed for enabling setting operations with respect to the task corresponding to the selected button. The task setting screen may vary depending on the settings designated for each task at the workflow generation screen 570, for example.

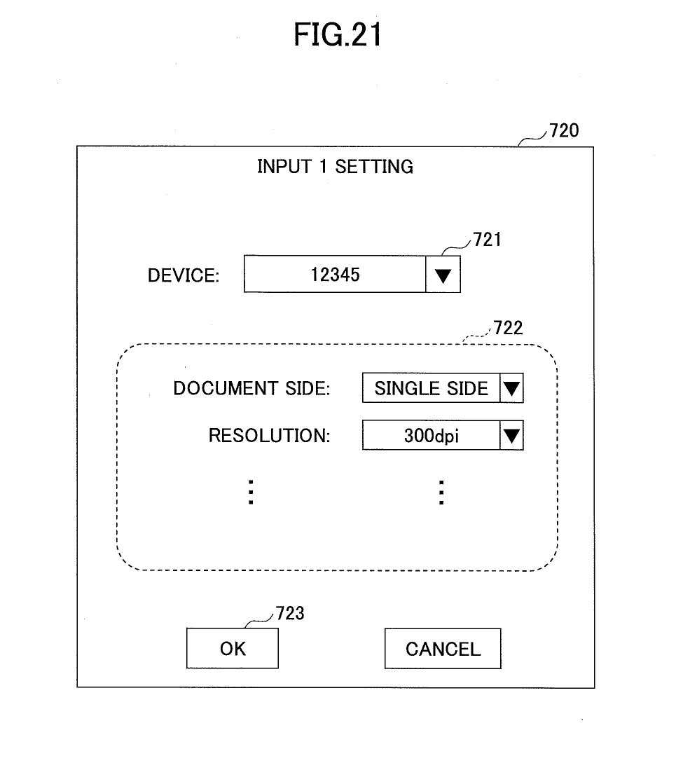

With respect to the input task, for example, an input task setting screen may be displayed based on the input method and input source stored in the input task table Tw2 (FIG. 18) of the workflow information of the target workflow. In a case where “scan” is set up as the input method and “device” is set up as the input source as illustrated in FIG. 18, an input task setting screen as illustrated in FIG. 21 may be displayed, for example.

FIG. 21 illustrates an exemplary input task setting screen 720. In FIG. 21, the input task setting screen 720 includes a list box 721 and a scan setting area 722.

The list box 721 is a display component for prompting selection of a specific device 10 that is to act as the input source; namely, the device 10 that is to execute the input task. For example, the list box 721 may display a list of device numbers included in the device information entries stored in association with the organization ID of the organization of the login administrator in the device information storage part 232 (FIG. 5) that include “scan” as capability information relating to an input task. In other examples, character strings or some other identifiers for distinguishing one device 10 over another device 10 may be used instead of the device number.

The scan setting area 722 is for accepting setting values of settings related to scanning. The content displayed at the scan setting area 722 may vary depending on the selection made at the list box 721. That is, the scan setting area 722 is configured to display settings according to the capability information of the selected device 10.

After requisite information items are set up in the input task setting screen 720 and an OK button 723 is pressed, the administrator terminal 30 stores the setting information accepted at the input task setting screen 720 as input task setting information in a memory in association with the task name of the input task. The input task setting information is stored as a part of setting information of the target workflow (referred to as “workflow setting information” hereinafter).

On the other hand, in a case where “upload” is set up as the input method and “storage” is set up as the input source in the input task table Tw2, a screen for designating a specific folder of a specific storage may be displayed as the input task setting screen, for example.

Further, in a case where “upload” is set up as the input method and “web,” “HTTP POST,” or “mail” is set up as the input source in the input task table Tw2, a screen for designating a specific URL or email address as an uploading destination may be displayed as the input task setting screen, for example. However, in other examples, the URL or email corresponding to the uploading destination may be automatically generated by the setting registration part 221. Note that a project associated with a given workflow may be unambiguously identified by a value based on an organization ID, profile name, group name, and project name. Thus, for example, the URL or email address corresponding to the uploading destination may include a value that connects the organization ID, profile name, group name, and project name associated with the project. The URL or email that is generated or designated as the uploading destination may be stored as input task setting information of the workflow setting information, for example.

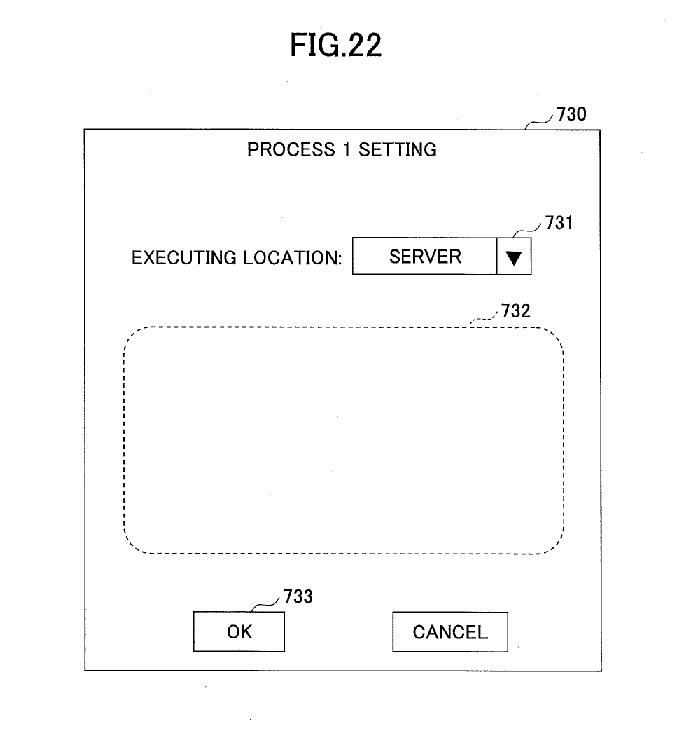

With respect to a process task, for example, a process task setting screen for prompting selection of an executing location of the process task may be displayed. For example, in a case where “OCR” is set up as the process name as illustrated in the process task table Tw3 of FIG. 18, a process task setting screen as illustrated in FIG. 22 may be displayed.

FIG. 22 illustrates an exemplary process task setting screen 730. In FIG. 22, the process task setting screen 730 includes a list box 731 and a setting area 732.

The list box 731 is a display component for prompting selection of a device 10 or an apparatus that is to execute the process task. The list box 731 displays a list including the device numbers of device information entries stored in the device information storage part 232 (FIG. 5) that include “OCR” as capability information relating to a process task. Also, in a case where the module ID of the OCR module 2271 is included in the module IDs stored as “purchased process” in the user information storage part 231 (FIG. 5) in association with the organization ID of the organization of the login administrator, the list displayed by the list box 731 may also include “server” as an option. In this case, “server” corresponds to a keyword referring to the service providing apparatus 20. Further, in a case where the module ID of the cloud OCR module 2277 is included in the module IDs stored as “purchased process” in the user information storage part 231 in association with the organization ID of the organization of the login administrator, the list displayed at the list box 731 may also include “cloud” as an option. Note that FIG. 22 illustrates an exemplary case where “server” is selected at the list box 731.

The setting area 732 is for accepting setting values for settings relating to an OCR process. The content displayed at the setting area 732 may vary depending on the selection made at the list box 731. For example, when a device number of a device 10 is selected at the list box 731, settings to be displayed may be determined based on detail information relating to OCR included in the device information stored in the device information storage part 232 in association with the selected device number, and the determined settings may be displayed at the setting area 722. In the case where “server” or “cloud” is selected at the list box 731, settings to be displayed may be determined based on attribute information of the OCR module 2271 or the cloud OCR module 2277 stored in the auxiliary storage device 202 in association with the OCR module 2271 or the cloud OCR module 2277, for example.

After requisite information items are set up in the process task setting screen 730 and an OK button 733 is pressed, the administrator terminal 30 stores the setting information accepted at the process task setting screen 730 as process task setting information in a memory in association with the task name of the process task. The process task setting information is stored as a part of the workflow setting information of the target workflow.

Note that although an exemplary process task setting screen relating to an OCR process is illustrated in FIG. 22, a process task setting screen may be displayed in a similar manner for setting information relating to a process task for executing some other process as well.

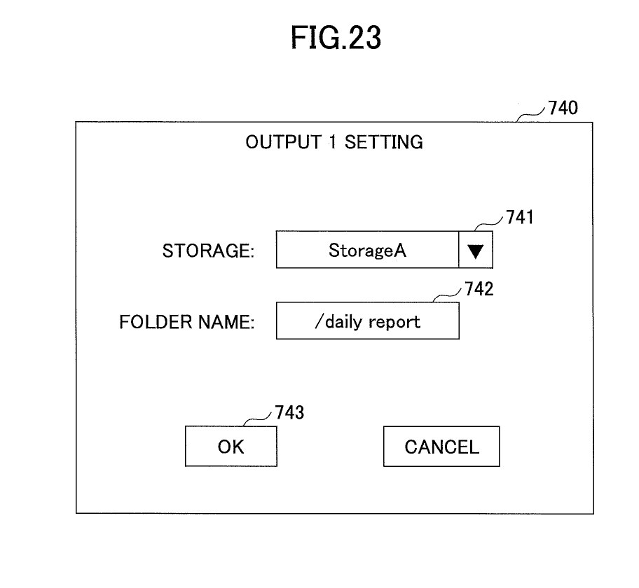

With respect to the output task, for example, an output task setting screen may be displayed based on the output destination stored in the output task table Tw4 (FIG. 18) for the target workflow. In a case where “storage” is set up as the output destination, for example, an output task setting screen as illustrated in FIG. 23 may be displayed.

FIG. 23 illustrates an exemplary output task setting screen 740. In FIG. 23, the output task setting screen 740 includes a list box 741 and a text box 742.

The list box 741 is a display component for prompting selection of a specific storage as an output destination. The list box 741 is configured to display a list including the storage names included in the storage account information stored in the user information storage part 231 in association with the organization ID of the organization of the login administrator (e.g., “Storage A”). The list displayed at the list box 741 also includes “server storage” as an option. In this context, “server storage” corresponds to a keyword referring to the server storage 237.

The text box 742 is a display component for prompting input of a folder name of a folder within the storage selected at the list box 741 that is to be the storage destination of data.

After requisite information items are set up at the output task setting screen 740 and an OK button 743 is pressed, the administrator terminal 30 stores the setting information accepted at the output task setting screen 740 as output task setting information in memory in association with the task name of the output task. The output task setting information is stored as part of the workflow setting information of the target workflow.

On the other hand, in a case where “device” is set up as the output destination in the output task table Tw4, for example, an output task setting screen may be displayed that includes a list box for prompting selection of a device number and a setting area displaying settings based on detail information stored as capability information relating to an output task in the device information storage part 232 in association with the device number selected at the list box. For example, in a case where the device number of a device 10 that is capable of executing a “print” process as an output task is selected at the list box, the setting area may display setting items based on detail information relating to the “print” process.

After requisite edits and settings are made at the profile edit screen 710 and the register button 718 is pressed (see FIG. 20), the administrator terminal 30 transmits a profile registration request including the edits and settings made at the profile edit screen 710 to the service providing apparatus 20 (S117 of FIG. 7). The edits and settings made at the profile edit screen 710 may include the flow name selected at the list box 713 and the workflow setting information of the corresponding workflow, for example. Note that the flow name and the workflow setting information may be set up for each project. Accordingly, in some cases, multiple sets of the flow name and workflow setting information may be included in the profile registration request.

Upon receiving the profile registration request from the administrator terminal 30, the setting registration part 221 of the service providing apparatus 20 registers the information included in the profile registration request in the profile storage part 234 in association with the organization ID of the login administrator (S118 of FIG. 7). Note that in a case where “upload” is set up as the input method of the input task, “web,” “HTTP POST,” or “mail” is set up as the input source of the input task, and the URL or email address corresponding to an uploading destination is to be automatically generated, the setting registration part 221 may generate the URL or email address corresponding to the uploading destination at this point in time, for example.

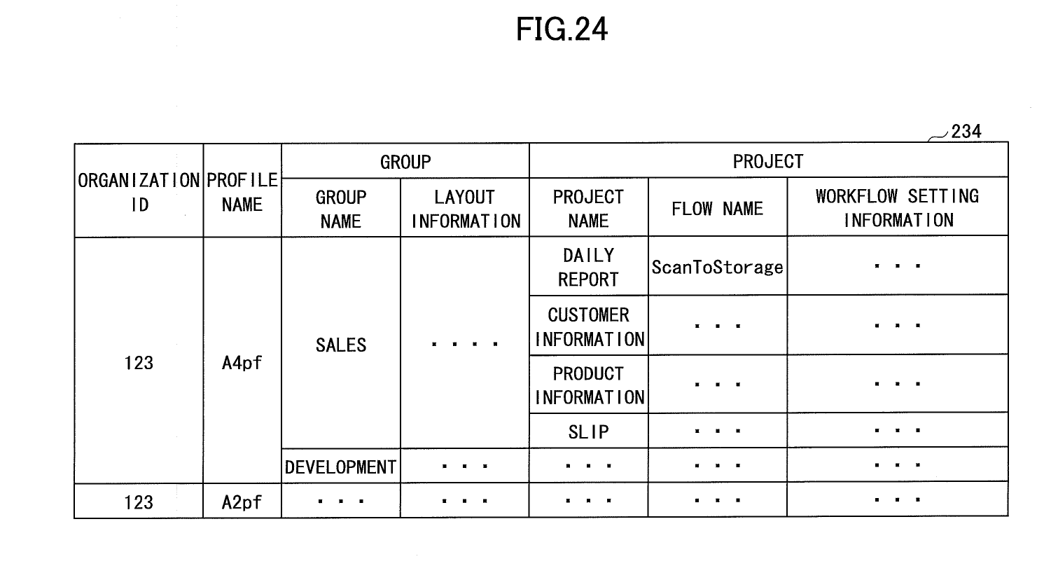

FIG. 24 illustrates an exemplary configuration of the profile storage part 234. In FIG. 24, the profile storage part 234 stores, for every profile, information items such as “organization ID,” “profile name,” “group,” and “project.”

“Organization ID” identifies the organization to which the profile belongs. “Profile name” indicates the name of the profile. “Group” indicates one or more groups included in the profile. In the present example, a record for a profile includes a record for each group included in the profile (referred to as “group record” hereinafter). “Project” indicates one or more projects included in a group. In the present example, a record for a group includes a record for each project included in the group (referred to as “project record” hereinafter).

One group record includes a group name, layout information, and at least one project record. The group name identifies the group and is also used as the label of the tab for the tab window corresponding to the group. The layout information includes information on the layout of buttons included in the tab window corresponding to the group.

One project record includes a project name, a flow name, and workflow setting information. The project name identifies the project and is also used as the label of the button corresponding to the project. As for the flow name and the workflow setting information, the information items set up for the project at the profile edit screen 710 of FIG. 20 are stored.

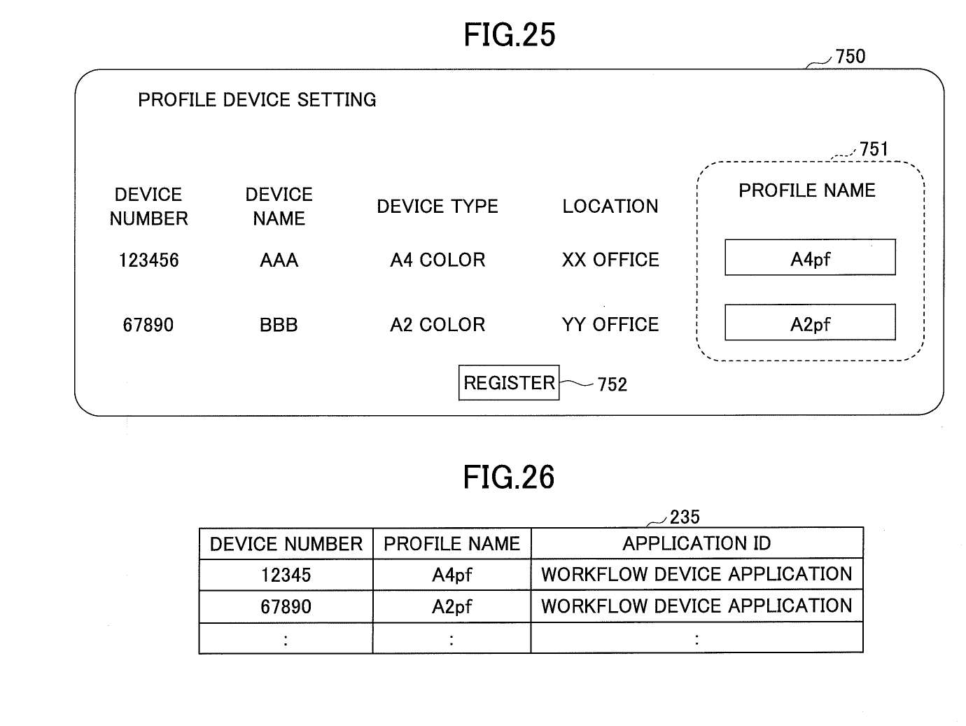

Next, when the device setting button 552 of the profile setting screen 550 illustrated in FIG. 8 is pressed by the administrator, the administrator terminal 30 displays a profile-device setting screen 750 as illustrated in FIG. 25, for example.

FIG. 25 illustrates an exemplary display of the profile-device setting screen 750. The profile-device setting screen 750 is for setting up the profile associated with each device 10. In FIG. 25, the profile-device setting screen 750 displays device information and a profile name input area 751 for each device 10 that has its device information registered in the device information storage part 232 in association with the organization ID of the login administrator. The administrator inputs the profile name of the profile to be associated with each device (the profile to be used at each device 10) to the profile name input area 751 and presses a register button 752.

When the register button 752 is pressed, the administrator terminal 30 transmits a registration request including the information on the settings made via the profile-device setting screen 750 (e.g., device number and profile name combinations) to the service providing apparatus 20. Upon receiving the registration request from the administrator terminal 30, the setting registration part 221 of the service providing apparatus 20 registers the information included in the registration request in the profile-device correspondence storage part 235.

FIG. 26 illustrates an exemplary configuration of the profile-device correspondence storage part 235. In FIG. 26, the profile-device correspondence storage part 235 stores a device number, a profile name, and the application ID of a device application in association with each other. The application ID associated with a device corresponds to the application ID of the device application selected at the marketplace screen 540 of FIG. 8. That is, the setting registration part 221 stores the application ID of the selected device application in the memory device 203 in association with the login administrator, and upon receiving the registration request including the information on the settings made at the profile-device setting screen 750, the setting registration part 221 stores the application ID in the profile-device correspondence storage part 235 in association with the setting information.

Next, when a logout button 536 of the administrator portal screen 530 of FIG. 8 is pressed (S119 of FIG. 7), the administrator terminal 30 transmits a logout request to the service providing apparatus 20. Upon receiving the logout request from the administrator terminal 30, the service providing apparatus 20 cancels the login status of the login administrator.

By performing the above-described procedures, preparatory operations by the administrator for enabling use of the workflow service may be completed.

In the following, process steps that are executed within the information processing system 1 when the workflow service is used by a member user are described.

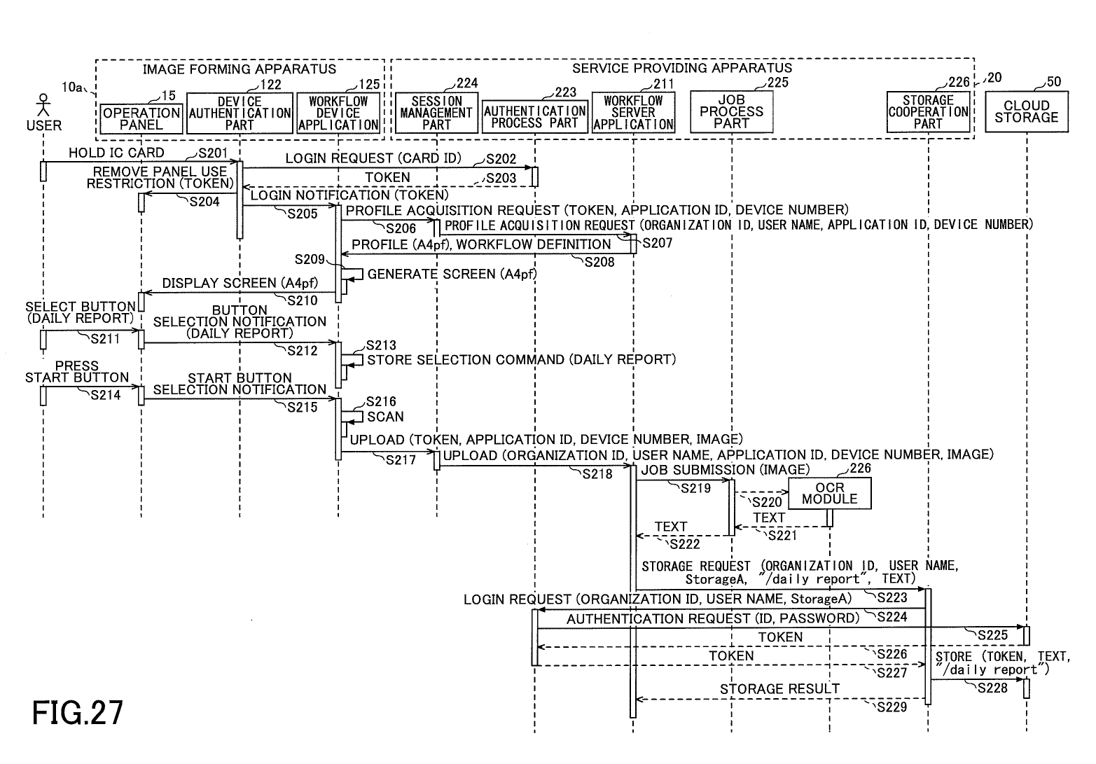

FIG. 27 is a sequence chart illustrating exemplary process steps that are executed upon using the workflow service of the present embodiment. In the following descriptions, it is assumed that the image forming apparatus 10a is being operated. Also, the member user operating the image forming apparatus 10a may simply be referred to as “user.” Further, it is assumed that no user is logged into the image forming apparatus 10a at the time the process of FIG. 27 is started.

When the user holds his/her IC card against a card reader (not shown) of the image forming apparatus 10a to which the user wishes to login, the device authentication part 122 obtains the card ID of the IC card via the card reader (S201). Then, the device authentication part 122 transmits an authentication request including the card ID to the service providing apparatus 20 (S202).

Upon receiving the authentication request from the image forming apparatus 10a, the authentication process part 223 of the service providing apparatus 20 authenticates the card ID included in the authentication request. For example, the authentication process part 223 may determine that authentication of the card ID is successful if a record including the card ID is stored in the user information storage part 231. In another example, the image forming apparatus 10a may transmit its organization ID and device number along with the card ID. In this case, the authentication process part 223 may determine that authentication is successful if there is no inconsistency in the combination of the organization ID, the device number, and the card ID. If authentication is successful, the session management part 224 establishes a session between the image forming apparatus 10a and the service providing apparatus 20. The session management part 224 determines the organization ID and the user name that is stored in association with the card ID within the user information storage part 231 and stores the associated organization ID and user name in the memory device 203 in association with this session. Also, the session management part 224 generates a token (e.g., cookie) as identification information of this session. The authentication process part 223 includes this token in a response indicating successful authentication to the device authentication part 122 of the image forming apparatus 10a (S203).

Upon receiving the response indicating successful authentication, the device authentication part 122 stores the token included in this response in the RAM 112. Also, the device authentication part 122 removes the use restriction (lock) implemented on the operation panel 15 so that the user may be able to operate the image forming apparatus 10a (S204). When the user restriction is removed, the user may operate the image forming apparatus 10a via the operation panel 15.

Next, the device authentication part 122 notifies one or more applications running on the image forming apparatus 10a of the successful login operation. In the present embodiment, the workflow device application 125 is one of the applications receiving notification of the successful login operation (S205). The token is included in the successful login notification. Thus, the workflow device application 125 acquires the token via this successful login notification.

Next, when the workflow device application 125 is selected for use by the user through operation of the operation panel 15, the workflow device application 125 designates its application ID, the acquired token, and the device number of the image forming apparatus 10a in a profile acquisition request, and sends this profile acquisition request to the workflow server application 211 of the service providing apparatus 20 (S206). The session management part 224 of the service providing apparatus 20 relays this profile acquisition request to the workflow server application 211. Upon relaying the profile acquisition request, the session management part 224 converts the token included in the profile acquisition request into the organization ID and user name associated with the session identified by the token and forwards the profile acquisition request to the workflow server application 211 (S207). Further, the session management part 224 is configured to reject a profile acquisition request that includes an illegitimate token.

Next, the workflow server application 211 refers to the profile-device correspondence storage part 235 (FIG. 26) to determine the profile name associated with the application ID and device number designated in the profile acquisition request. Further, the workflow server application 211 acquires from the profile storage part 234 (FIG. 24) the corresponding profile identified by the profile name and the organization ID converted from the token. Further, the workflow server application 211 acquires from the workflow definition storage part 236 a list of workflow definition information that is stored in association with the organization ID (see e.g., FIGS. 17 and 18). Then, the workflow server application 211 transmits the acquired profile and the list of workflow definition information to the workflow device application 125 (S208).

Based on the profile received from the workflow server application 211, the workflow device application 125 generates an operation screen (S209). Then, the workflow device application 125 prompts the operation panel 15 to display the generated operation screen (S210). Note that strictly speaking, the generation of the operation screen based on the profile and the display of the operation panel is implemented by the display control part 124.

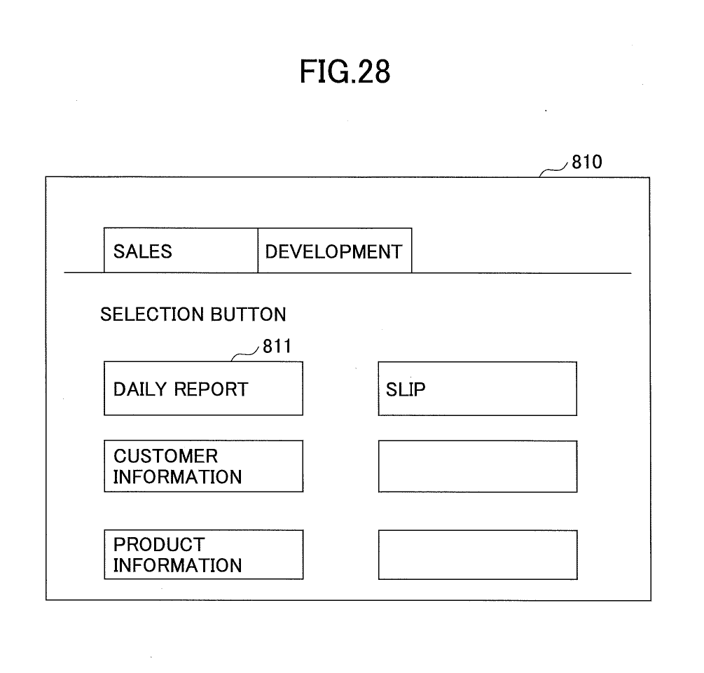

FIG. 28 illustrates an exemplary display of an operation screen 810 of the workflow device application 125. The operation screen 810 illustrated in FIG. 28 corresponds to the screen displayed at the edit target screen display area 712 of the profile edit screen 710 illustrated in FIG. 20.

Next, the user selects a desired button from selection buttons displayed at the operation screen 810 (S211). For example, if the user wishes to have a daily report scanned, the user may select a daily report button 811 from the operation screen 810. In turn, the operation panel 15 notifies the workflow device application 125 of the button selected by the user (S212), and the workflow device application 125 extracts information items such as the group name, project name, workflow setting information, and workflow definition information (FIGS. 17 and 18) associated with the selected daily report button 811 from the profile and the list of workflow definition information and stores the extracted information items in the RAM 112 as information pertaining to the target workflow (S213). The information items such as the workflow setting information may be included in the profile used for generating the operation screen 810, for example. Also, the workflow definition information for the selected button 811 may be determined based on the flow name associated with the project represented by the selected button 811. In the present example, it is assumed that the workflow definition information of the target workflow corresponds to the workflow information illustrated in FIG. 18 that defines tasks of the corresponding workflow to be executed in the order “task [input 1]→task [process 1]→task [output 1].”

The workflow device application 125 refers to the flow definition table tw1 of the workflow definition information of the target workflow to recognize that task [input 1] corresponds to an input task. Also, the workflow device application refers to the input task table Tw2 to recognize that a “scan” process is to be executed by the corresponding input task. Also, the workflow device application 125 refers to the input task setting information of the workflow setting information relating to the target workflow to determine that the device number included in the input task setting information corresponds to the device number of the image forming apparatus 10a. Accordingly, the workflow device application 125 may recognize that the task [input 1] corresponding to an input task is to be executed at the image forming apparatus 10a. In turn, the workflow device application 125 prompts the operation panel 15 to display a message prompting execution of the scan process.

Next, the user sets the daily report as a document to be scanned on the image forming apparatus 10a and presses a start button displayed on the operation panel 15 (S214). In turn, the operation panel 15 notifies the workflow device application 125 that the start button has been selected (S215). In response to the start button selection notification, the workflow device application 125 prompts the image forming apparatus 10a to execute the scan job on the document via the device control part 121 (S216). That is, the scanner 12 is prompted to read image data from the document. In this operation, the scanning conditions may be based on the input task setting information of the workflow setting information relating to the target workflow stored in the RAM 112. In this way, suitable scanning conditions for scanning a daily report may be used to scan the document and generate image data of the document.

Next, the workflow device application 125 transmits (uploads) the image data along with its application ID, the device number of the image forming apparatus 10a, the group name and project name of the selected button, the task name (“input 1”) of the executed task [input 1], and the token of the current session to the workflow server application 211 (S217). The session management part 224 converts the token into the corresponding organization ID and user name, and forwards the organization ID and user name converted from the token, the application ID, the device number, the group name, the project name, the executed task name, and the image data to the workflow server application 211 (S218).

The workflow server application 211 determines the profile corresponding to the forwarded application ID and device number based on the profile-device correspondence storage part 235 and the profile storage part 234, and determines the flow name and workflow setting information associated with the forwarded group name and project name by referring to this profile. Further, the workflow server application 211 acquires workflow definition information associated with the flow name determined above from the workflow definition storage part 236.

Next, the workflow server application 211 determines, based on the flow definition table tw1 (FIG. 18) of the acquired workflow definition information and the executed task name, that task [process 1] corresponds to the next task to be executed. Further, the workflow server application 211 determines based on the process task table Tw3 (FIG. 18) of the acquired workflow definition information that task [process 1] corresponds to an OCR process.

Accordingly, the workflow server application 211 submits a job execution request for executing a job relating to an OCR process (referred to as “job A” hereinafter) to the job process part 225 (S219). The job execution request includes information items such as the process task setting information of task [process 1] and the scanned image data associated with each other. In the present example, the job execution request is accumulated at a job queue that is created within the RAM 112, for example. That is, the requested job is not executed in synch with the job execution request. However, in other embodiments, the job may be executed in synch with the job execution request.

Next, when the job process part 225 extracts job A from the job queue, the job process part 225 requests the OCR process module 2271 to execute an OCR process based on the process task setting information of job A for the image forming apparatus 10a associated with job A (S220). In turn, the OCR process module 2271 executes the OCR process on the image data and outputs text data as the processing result (S221). Then, the job process part 225 outputs the text data to the workflow server application 211 (S222).

Next, the workflow server application 211 determines, based on the flow definition table Tw1 of the workflow definition information of the target workflow, that task [output 1] corresponding to an output task is to be executed after task [process 1]. Also, the workflow server 211 determines based on the output task table Tw4 that “storage” is the output destination for task [output 1]. Further, the workflow server 211 determines based on the output task setting information of task [output 1] that a folder identified by the folder name “/daily report” within the cloud storage 50 that is identified by the storage name “Storage A” corresponds to the specific output destination for task [output 1] (see FIG. 23).

Accordingly, the workflow server application 211 sends a storage request for storing the output text data to the storage cooperation part 226, designating information such as the output text data, the organization ID, the user name, the storage name (“Storage A”), and the folder name (“/daily report”) (S223).

Note that in a case where “server storage” is designated as the output destination storage, the workflow server application 211 stores the output text data in the server storage 237 rather than sending the storage request to the storage cooperation part 226.

The storage cooperation part 226 sends a login request for logging into the cloud storage 50 with the designated storage name to the authentication process part 223 (S224). The storage cooperation part 226 designates in the login request the organization ID and storage name designated in the storage request. The authentication process part 223 acquires the organization record with the designated organization ID from the user information storage part 231, and acquires the account information (ID and password) associated with the designated storage name from the storage account information of the acquired organization record. The authentication process part 223 may use the acquired account information to transmit an authentication request to the cloud storage 50 identified as “Storage A” (simply referred to as “Storage A” hereinafter), for example (S225).

Storage A authenticates the account information included in the authentication request from the authentication process part 223, and transmits, upon successful authentication, a token for accessing Storage A to the authentication process part 223 (S226). The authentication process part 223 transmits the received token to the storage cooperation part 226 (S227).

Next, the storage cooperation part 226 transmits a storage request for storing the output text data to the cloud storage 50 identified by the storage name (“Storage A”) designated in the storage request received from the workflow server application 211, the storage request designating the token for accessing Storage A received from the authentication process part 223 (S228). The storage request also designates the folder name (“/daily report”) that is designated in the storage request from the workflow server application 211 as the storage destination folder.

In this way, the output text data may be stored in the “/daily report” folder of Storage A. Next, the storage cooperation part 226 sends a response including a storage result relating to whether the output text data has been successfully stored to the workflow server application 211 (S229). Upon determining based on the flow definition table tw1 of the workflow definition information of the target workflow that task [output 1] corresponds to the end of the target workflow, the workflow server application 211 ends the target workflow.

Note that in some embodiments, information identifying a workflow execution may be added with respect to each workflow execution. For example, the workflow server application 211 may store log information including the execution result of each task making up the target workflow in the auxiliary storage device 202. The log information may be stored in a batch upon completion of the target workflow, or the log information may be stored each time a task of the target workflow is completed. By storing the log information each time a task is completed, the log information may be used to check the progress of the target workflow in a case where a relatively long time period is required to complete execution of the target workflow, for example.

Note that the above example illustrates a case where “device” is designated as the input source and “scan” is designated as the input method. On the other hand, in a case where “upload” is designated as the input source and “web,” “HTTP POST,” or “mail” is designated as the input method, the workflow server application 211 may execute the following process steps, for example.

Upon receiving data via an HTTP request or an email, the workflow server application 211 searches the profile storage part 234 for a project associated with the destination URL of the HTTP request or the destination email address of the email as a target project. The project associated with the destination URL or the destination email address refers to a project registered in the profile storage part 234 that has the destination URL or the destination email address included in its input task setting information of the workflow setting information.

Next, the workflow server application 211 acquires workflow definition information of the workflow identified by the flow name associated with the searched project from the workflow definition storage part 236.

Next, the workflow server application 211 controls the workflow executed with respect to uploaded data based on the workflow definition information acquired from the workflow definition storage part 236 and the workflow setting information of the target project acquired from the profile storage part 234. For example, in a case where the process task and the output task are the same as the example illustrated in FIG. 27, process steps identical to steps S219-S229 may be executed with respect to the uploaded data.

In the following, other exemplary workflows according to embodiments of the present invention are described with reference to specific use cases.

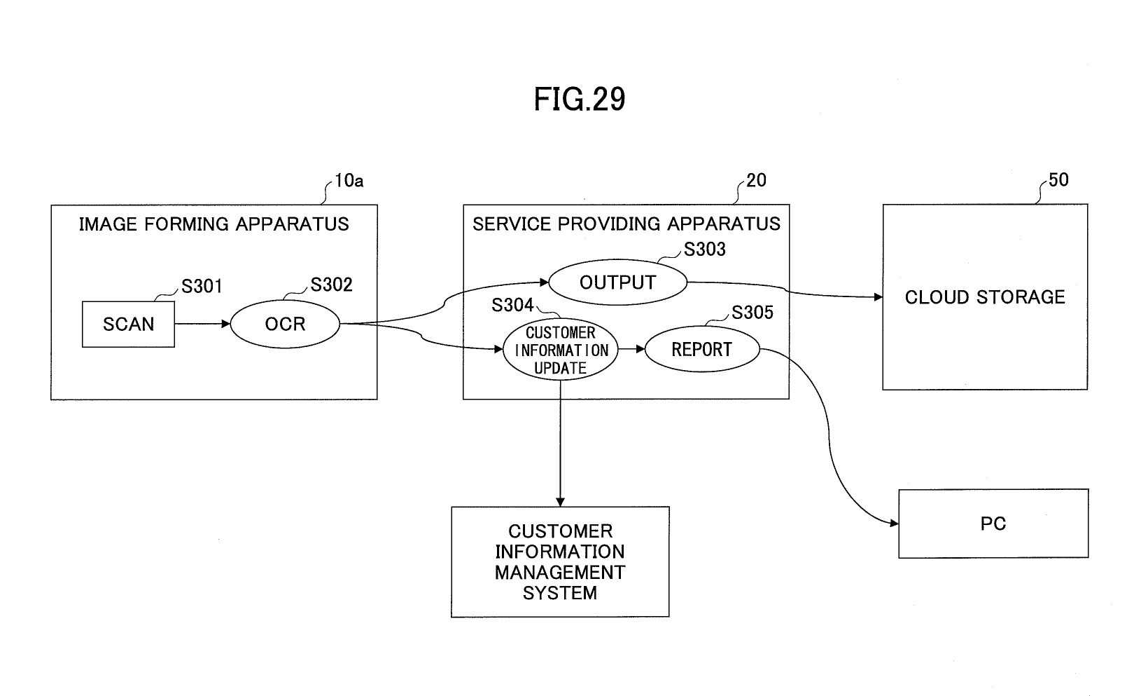

FIG. 29 illustrates an exemplary workflow for a first use case. In FIG. 29, a provider of a given service (referred to as “service A” hereinafter) corresponds to the user of the workflow service, and the illustrated workflow (referred to as “workflow A” hereinafter) is used in a case where a customer service representative of service A receives an application form relating to a change in customer information from a customer. The application form may be an address change notice form, for example.

In response to an operation command input by the customer service representative, the image forming apparatus 10a scans the application form as an input task to obtain image data of the application form (S301). Next, the image forming apparatus 10a executes an OCR process on the scanned image data of the application form as a process task (S302). Then, the image forming apparatus 10a transmits text data output as the processing result of the OCR process to the service providing apparatus 20. Note that in some embodiments, the OCR process may be executed at the service providing apparatus 20 rather than the image forming apparatus 10a.

The service providing apparatus 20 stores the text data in the cloud storage 50 as an output task (S303). Also, the service providing apparatus 20 executes a customer information update process on a customer information management system as a process task (S304). That is, after the OCR process of step S302, workflow A branches out to the output task for storing data in the cloud storage 50 and the process task for the customer information update process. In one preferred embodiment, a process module for executing the customer information update process may be added to the process part 227 (FIG. 5) of the service processing apparatus 20 and the process task for the customer information update process may be executed by this process module. After the customer information update process is completed, the service providing apparatus 20 sends an application receipt notification to a PC of the customer via email, for example (S305). The transmission of the receipt notification may be executed by the reporting module 2275, for example.

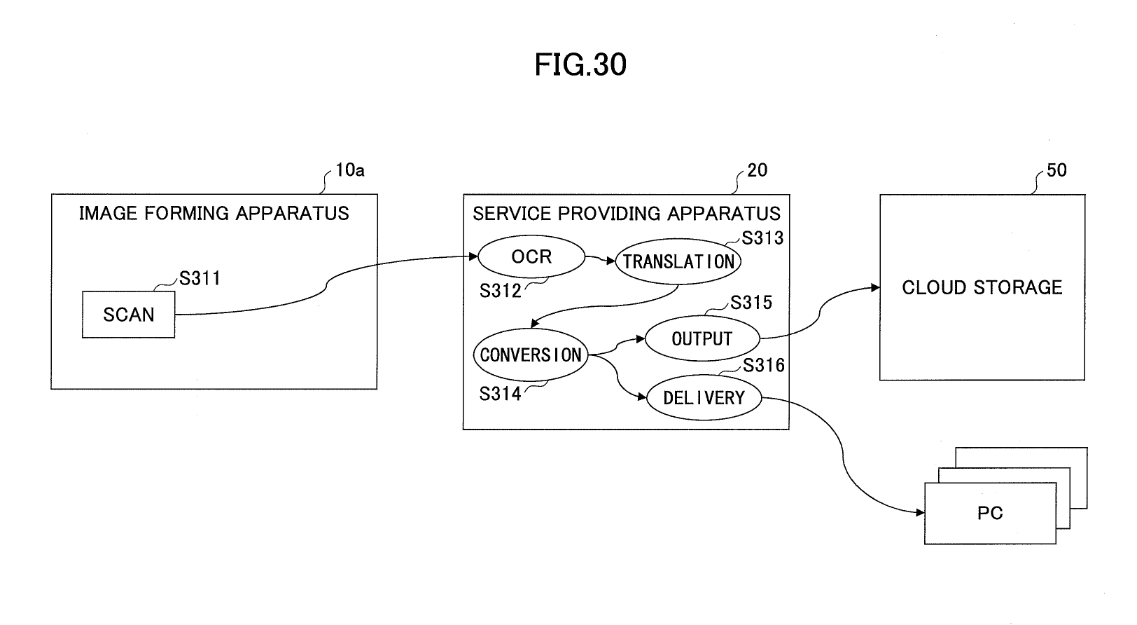

FIG. 30 illustrates an exemplary workflow for a second use case. Specifically, FIG. 30 illustrates a workflow for translating a document and delivering the translated document to relevant parties.

The image forming apparatus 10a scans a document as an input task (S311). The image forming apparatus 10a transmits the scanned image data of the document to the service providing apparatus 20.

The service providing apparatus 20 executes an OCR process on the image data as a process task (S312). Next, the service providing apparatus 20 executes a translation process on text data output as the processing result of the OCR process as a process task (S313). The translation process may be executed by the translation module 2272, for example. Next, the service providing apparatus 20 executes a conversion process to convert text data representing the translation result into PDF data as a process task (S314). The conversion process may be executed by the conversion module 2274, for example. Next, the service providing apparatus 20 stores the PDF data in the cloud storage 50 as an output task (S315). Also, the service providing apparatus 50 delivers the PDF data to relevant parties (e.g., by email) as a process task (S316).

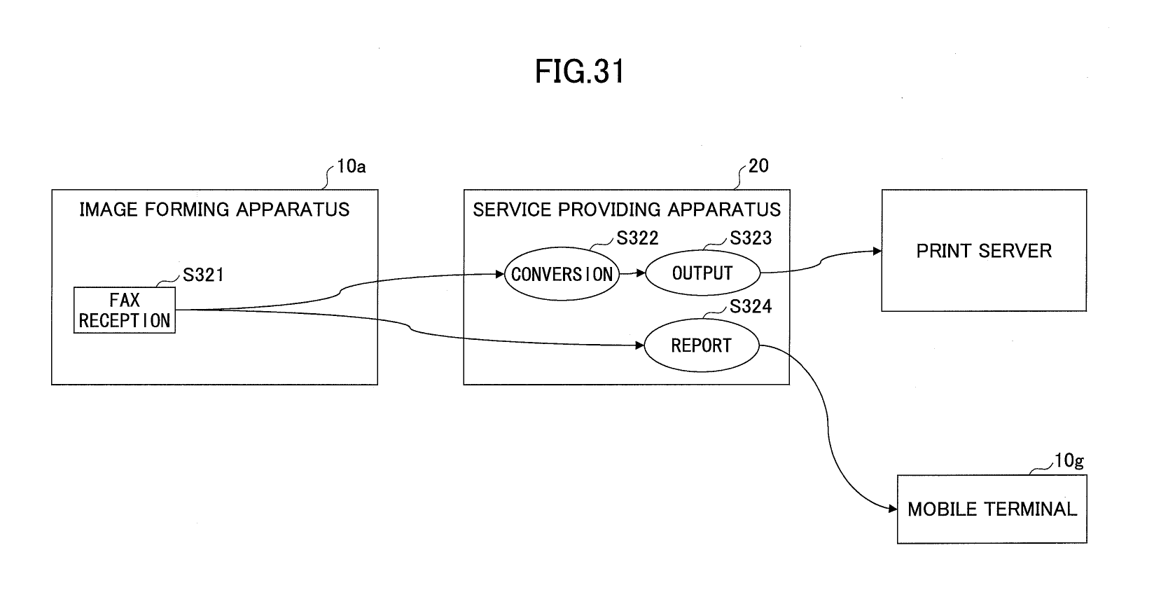

FIG. 31 illustrates an exemplary workflow for a third use case. Specifically, FIG. 31 illustrates a workflow that is executed upon receiving a fax.

Upon receiving a fax as an input task, the image forming apparatus 10a transmits electronic data of the received fax document (referred to as “document data” hereinafter) to the service providing apparatus 20 (S321). Note that in the present example, the image forming apparatus 10a does not print out the received fax document.

The service providing apparatus 20 executes a conversion process to convert the document data into print data as a process task (S322). The conversion process may be executed by the conversion module 2274, for example. Next, the service providing apparatus 20 transmits the resulting print data to a print server as an output task (S323). Note that in the present example, the print data is not printed out immediately but is instead stored within the print server until an acquisition request for the print data is issued from the image forming apparatus 10a.

The service providing apparatus 20 also transmits a fax receipt notification (e.g., by email) to the mobile terminal 10g of a user, for example (S324). The transmission of the notification may be executed by the reporting module 2275, for example.

Then, the user that has received the notification may operate the image forming apparatus 10a to prompt the image forming apparatus 10a to retrieve the print data stored in the print server and print out the retrieved print data.

By implementing the workflow as described above rather than having a fax document printed out immediately upon its receipt, the fax document may be less likely to be abandoned and exposed to others. Accordingly, security in connection with fax reception may be improved, for example.

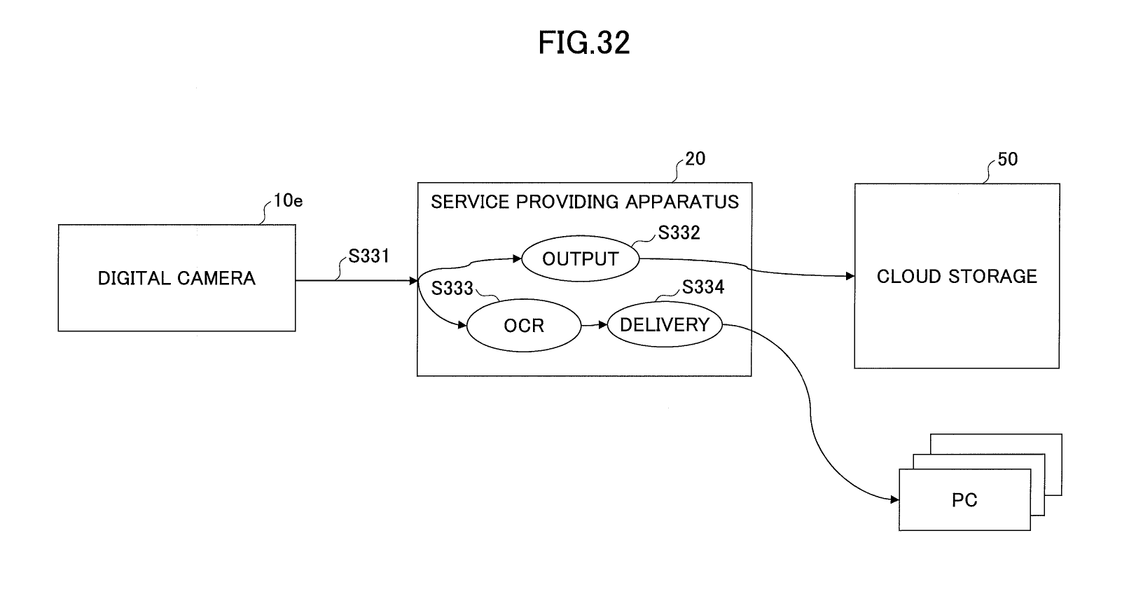

FIG. 32 illustrates an exemplary workflow for a fourth use case. Specifically, FIG. 32 illustrates a workflow for enabling easy distribution of minutes of a meeting.

For example, during a meeting, a user may capture an image of notes written on a white board using the digital camera 10e and upload the captured image data to the service providing apparatus 20 (e.g., via HTTP POST or email) (S331). Note that the uploading process does not have to be executed directly from the digital camera 10e. For example, the captured image data may be stored in a PC before being uploaded to the service providing apparatus 20.

Note that the input method of the input task of the present workflow is “upload,” and the input source of the input task may be “web,” “HTTP POST,” or “mail.” In this case, the service providing apparatus 20 (i.e., workflow server application 211) controls execution of the workflow based on the workflow setting information and the workflow definition information associated with the URL or email address designated as the uploading destination.

For example, the service providing apparatus 20 may store uploaded image data in the cloud storage 50 as an output task (S332). Also, the service providing apparatus 20 may execute an OCR process on the uploaded image data as a process task (S333). Next, the service providing apparatus 20 may execute a delivery process as a process tasks for delivering text data output as the processing result of the OCR process to relevant parties by email, for example (S334). The delivery process may be executed by the delivery module 2276, for example. Note that in some cases, a user may perform editing operations on the text data before delivering the text data to the relevant parties, for example.

As can be appreciated from above, according to an aspect of the present invention, a workflow service provided by the service providing apparatus 20 may be configured by setting up the processes of the workflow in task units. Also, each task making up the workflow may be executed at any device that is capable of establishing communication via a network including but not limited to any of the devices 10 and the service providing apparatus 20. In this way, a flexible service may be provided by the service providing apparatus 20, for example.

Also, in prompting selection of the device 10 that is to execute each task, the devices 10 to be presented as options may be restricted based on the capability information of the devices 10. In this way, a task may be prevented from being assigned to a device 10 that does not have the capability (function) to execute the corresponding process of the task, and at the same time, the work load for generating the workflow may be reduced, for example.

Note that the service providing apparatus 20 described above corresponds to an exemplary embodiment of an information processing apparatus. The device 10 described above corresponds to an exemplary embodiment of a processing apparatus. The workflow definition information described above corresponds to an exemplary embodiment of order information. The workflow setting information described above corresponds to an exemplary embodiment of association information. The workflow definition storage part 236 described above corresponds to an exemplary embodiment of an order information storage part. The profile storage part 234 described above corresponds to an exemplary embodiment of an association information storage part. The setting registration part 221 described above corresponds to an exemplary embodiment of a setting part. The workflow server application 211 described above corresponds to an exemplary embodiment of an order control part. The device information storage part 232 described above corresponds to an exemplary embodiment of a capability information storage part.

Although the present invention has been described above with reference to certain preferred embodiments, the present invention is not limited to these embodiments, and numerous variations and modifications may be made without departing from the scope of the present invention.

The present application is based on and claims the benefit of priority of Japanese Patent Application No. 2012-246250 filed on Nov. 8, 2012, the entire contents of which are hereby incorporated by reference.

What is claimed is:

1. An information processing apparatus comprising:
an order information storage part that stores order information defining an order in which a plurality of processes are to be executed with respect to data;
a setting part that prompts selection of a processing apparatus that is to execute a process of the plurality of processes from one or more processing apparatuses, and stores association information indicating an association between the process and the selected processing apparatus in an association storage part; and
an order control part that prompts the one or more processing apparatuses that are associated with the plurality of processes to execute the plurality of processes in the order defined by the order information.

2. The information processing apparatus as claimed in claim 1, further comprising:
a capability information storage part that stores capability information indicating a capability of the one or more processing apparatuses to execute one or more of the plurality of processes;
wherein the setting part prompts selection of the processing apparatus that is to execute the process from the one or more processing apparatuses that are determined to be capable of executing the process based on the capability information.

3. The information processing apparatus as claimed in claim 1, wherein
in a case where the order information defines a process of receiving data via a network as a first process to be executed, the order information is associated with a destination of the data; and
when the data is received, the order control part prompts the one or more processing apparatuses that are associated with the plurality of processes to execute the plurality of processes in the order defined by the order information that is associated with the destination of the data.

4. An information processing system including a plurality of processing apparatuses, the information processing system comprising:
an order information storage part that stores order information defining an order in which a plurality of processes are to be executed with respect to data;
a setting part that prompts selection of a processing apparatus of the plurality of processing apparatuses that is to execute a process of the plurality of processes, and stores association information indicating an association between the process and the selected processing apparatus in an association storage part; and
an order control part that prompts one or more of the processing apparatuses that are associated with the plurality of processes to execute the plurality of processes in the order defined by the order information.

5. The information processing system as claimed in claim 4, further comprising:
a capability information storage part that stores capability information indicating a capability of the plurality of processing apparatuses to execute one or more of the plurality of processes;
wherein the setting part prompts selection of the processing apparatus that is to execute the process from one or more of the processing apparatuses that are determined to be capable of executing the process based on the capability information.

6. The information processing system as claimed in claim 4, wherein
in a case where the order information defines a process of receiving data via a network as a first process to be executed, the order information is associated with a destination of the data; and
when the data is received, the order control part prompts the one or more processing apparatuses that are associated with the plurality of processes to execute the plurality of processes in the order defined by the order information that is associated with the destination of the data.

7. An information processing method that is executed by a computer, the method comprising:
a setting step that includes prompting selection, from one or more processing apparatuses, a processing apparatus ‘that is to execute a process of a plurality of processes that are defined in order information indicating an order in which the plurality of processes are to be executed with respect to data, and storing association information indicating an association between the process and the selected processing apparatus in an association information storage part; and
an order controlling step that includes prompting the one or more processing apparatuses that are associated with the plurality of processes to execute the plurality of processes in the order defined by the order information.

8. The information processing method as claimed in claim 7, wherein
the setting step further includes determining whether the one or more processing apparatuses are capable of executing the process based on capability information indicating a capability of the one or more processing apparatuses to execute one or more of the plurality of processes, and prompting selection of the processing apparatus that is to execute the process from the one or more processing apparatuses that are determined to be capable of executing the process.

9. The information processing method as claimed in claim 7, wherein
in a case where the order information defines a process of receiving data via a network as a first process to be executed, the order information is associated with a destination of the data; and
the order controlling step includes prompting the one or more processing apparatuses that are associated with the plurality of processes to execute the plurality of processes in the order defined by the order information that is associated with the destination of the data upon receiving the data.
